(19) United States
(12) Patent Application Publication
(10) Pub. No.: US 2024/0378814 A1
(43) Pub. Date: Nov. 14, 2024

(54) COHESIVE ZONE-BASED CRITERIA FOR ADAPTIVITY DRIVEN DEBONDING ANALYSIS

(71) Applicant: ANSYS, Inc., Canonsburg, PA (US)

(72) Inventors: Andrea KESSLER, Weimar (DE); Siddhartha MUKHERJEE, Pittsburgh, PA (US); Srivatsa Madhusudhan SHARMA, McMurray, PA (US); Jin WANG, Venetia, PA (US); Ameya Vinayak KHISTY, Nagpur (IN)

(21) Appl. No.: 18/314,567

(22) Filed: May 9, 2023

(51) Int. Cl. G06T 17/20

(52) U.S. Cl. CPC G06T 17/205

(57) ABSTRACT

The present disclosure relates to criteria for adaptive remeshing in debonding simulations. For example, one or more embodiments described herein include a computer-implemented method comprising determining, by a processor, a released energy, a damage parameter value, or a contact status of a contact element included within a first mesh that represents a region of physical objects simulated by a cohesive zone model. The computer-implemented method can also comprise remeshing, by the processor, a finite element associated with the contact element to generate a second mesh to represent the region based on the released energy, the damage parameter value, or the contact status to obtain physical characteristics associated with a debonding of the physical objects.

### FIELD OF THE DISCLOSURE

The present disclosure relates generally to numerical simulations of debonding and, more particularly, to criteria for adaptive remeshing in debonding simulations.

### BACKGROUND OF THE DISCLOSURE

Cohesive zone models are typically used in debonding analyses to simulate the behavior of an interface between two materials that may separate or debond under loading conditions. For example, cohesive zone models can employ a finite element method used in computational mechanics to simulate the behavior (e.g., represented by a traction-displacement curve) of the two materials under stress and strain. For example, adhesion between the materials can be governed by a defined cohesive law (e.g., a specified traction-displacement law). Thereby, cohesive zone models can describe the cohesive forces that occur when materials are pulled apart to enable the prediction of a debonding initiation and/or propagation.

The finite elements are represented by a structured or unstructured mesh, which is adaptively modified to adjust the resolution of targeted areas as the simulation progresses. For example, an area of the mesh can be refined to increase the accuracy of the model in simulating the given area (e.g., improve the resolution of the area) by increasing the number of finite elements. Alternatively, an area of the mesh can be coarsened (e.g., by reducing the number of finite elements while preserving the overall behavior of the mode of fracture) where less accuracy is required to reduce computational expenditures. Further, the cohesive zone model can utilize non-linear adaptivity to dynamically implement the refining and/or coarsening of the mesh in response to changes in the computational solution (e.g., non-linear adaptivity uses a feedback mechanism to discretely or continuously adjust internal parameters automatically so that an accurate and convergent solution is obtained).

### SUMMARY OF THE DISCLOSURE

Computer implemented methods for adaptive remeshing in debonding simulations using cohesive-zone based criteria are described herein. According to an embodiment consistent with the present disclosure, a computer-implemented method is provided. The computer-implemented method can include: determining, by a processor, a released energy, a damage parameter value, or a contact status of a contact element included within a first mesh that represents a region of physical objects simulated by a cohesive zone model. The computer-implemented method can also include remeshing, by the processor, finite element associated with the contact element to generate a second mesh to represent the region based on the released energy, the damage parameter, or the contact status to obtain physical characteristics associated with a debonding of the physical objects.

In another embodiment, a further computer-implemented method is provided. The computer-implemented method can include: determining, by a processor, a released energy that characterizes a relative change of released energy of a contact element between substeps of a debonding in a region of physical objects simulated by a cohesive zone model, wherein the region is represented by a first mesh that includes the contact element. The computer-implemented method can also include remeshing, by the processor, a finite element associated with the contact element to generate a second mesh to represent the region based on the released energy to obtain physical characteristics associated with the debonding of the physical objects.

In a further embodiment, a further computer-implemented method is provided. The computer-implemented method can include: determining, by a processor, a damage parameter value of a contact element included within a first mesh that represents a region of physical objects simulated by a cohesive zone model, wherein the damage parameter is a function of displacement between the contact element and a target element. The computer-implemented method can also include remeshing, by the processor, a finite element associated with the contact element to generate a second mesh to represent the region based on the damage parameter or the contact status to obtain physical characteristics associated with a debonding of the physical objects.

This summary is not an extensive overview of the disclosure and is neither intended to identify certain elements of the disclosure, nor to delineate the scope thereof. Further embodiments, features, and advantages of the invention, as well as the structure and operation of the various embodiments of the invention are described in detail below with reference to accompanying drawings.

### BRIEF DESCRIPTION OF THE DRAWINGS

FIG. 1 illustrates a block diagram of a non-limiting example system that employs a debonding simulation solver for a numerical simulation of cohesive-zone debonding of an initial mesh in accordance with one or more embodiments described herein.

FIG. 2 illustrates a flow diagram of a non-limiting example computer-implemented method that can be implemented by the system to adaptively remesh and solve a debonding simulation in accordance with one or more embodiments described herein.

FIG. 3 illustrates a flow diagram of a non-limiting example computer-implemented method that can be implemented by the system to analyze target elements and paired contact elements of a mesh with respect to one or more remeshing criteria in accordance with one or more embodiments described herein.

FIG. 4 illustrates a flow diagram of a non-limiting example computer-implemented method that can be implemented by the system to calculate a relative change of released energy for one or more integration points of a contact element in accordance with one or more embodiments described herein.

FIG. 5 illustrates a diagram of a non-limiting example traction force-displacement curve that can characterize behavior of a cohesive zone material in accordance with one or more embodiments described herein.

FIG. 6 illustrates a flow diagram of a non-limiting example computer-implemented method that can be implemented by one or more systems to determine whether one or more damage parameter based remeshing criteria are satisfied in accordance with one or more embodiments described herein.

FIG. 7 illustrates a diagram of a non-limiting example cohesive zone that can be modeled by one or more debonding simulation solvers executing a numerical simulation of cohesive-zone debonding of an initial mesh in accordance with one or more embodiments described herein.

FIG. 8 illustrates a flow diagram of a non-limiting example computer-implemented method that can be implemented by the system to calculate a damage parameter value difference between one or more integration points of a contact element in accordance with one or more embodiments described herein.

FIG. 9 illustrates a flow diagram of a non-limiting example computer-implemented method that can be implemented by the system to determine an onset of damage associated with a contact element in accordance with one or more embodiments described herein.

FIG. 10 illustrates a flow diagram of a non-limiting example computer-implemented method that can be implemented by the system to determine a contact element's proximity to an onset of damage in a nearby contact element in accordance with one or more embodiments described herein.

FIG. 11 illustrates a flow diagram of a non-limiting example computer-implemented method that can be implemented by the system to calculate a damage parameter value difference between an integration point of the contact element and an integration point of one or more nearby contact elements that are in proximity to a selected contact element in accordance with one or more embodiments described herein.

FIG. 12 illustrates a flow diagram of a non-limiting example computer-implemented method that can be implemented by the system to determine whether a contact element satisfies a coarsening criterion in accordance with one or more embodiments described herein.

FIG. 13 illustrates a diagram of a non-limiting example cohesive zone that can be modeled by one or more debonding simulation solvers executing a numerical simulation of cohesive-zone debonding of an initial mesh in accordance with one or more embodiments described herein.

FIG. 14 illustrates results of a debonding simulation performed utilizing the system and the cohesive zone-based non-linear adaptivity criteria described by at least one of the computer-implemented methods discussed herein, and further compared to the fine mesh solution in accordance with one or more embodiments described herein.

FIG. 15 a block diagram of non-limiting example computer environment that can be implemented within one or more systems described herein.

### DETAILED DESCRIPTION

The following detailed description is merely illustrative and not intended to limit the scope and/or use of embodiments. Furthermore, there is no intention to be bound by any expressed or implied information presented in the preceding Background or Summary sections, or in the following Detailed Description section.

One or more embodiments are now described with reference to the Drawings, where like referenced numerals are used to refer to like elements throughout. In the following Detailed Description, for purpose of explanation, numerous specific details are set forth in order to provide a more thorough understanding of the one or more embodiments. However, it is evident that one or more embodiments can be practiced without these specific details.

Embodiments refer to illustrations described herein with reference to particular applications. It should be understood that the present description is not limited to the embodiments. Those skilled in the art with access to the teachings provided herein will recognize additional modifications, applications, and embodiments within the scope there and additional fields in which the embodiments would be of significant utility.

When modeling high-adhesion debonding between two materials (e.g., between two soft materials), the debonding can lead to high element deformation (e.g., a measure of deviation form an ideal shape, such as a cubic shape, of a standard finite element). Element deformation can be measured by, for example: aspect ratio, angle, skewness of the element, the Jacobian ratio, a combination thereof, and/or the like. Accurately representing the debonding process requires highly refined meshes. To implement refining operations on the mesh, typical non-linear adaptivity criteria focus on parameters of solid mechanics, such as mean strain energy of solid elements within the debonding analysis. However, the utilization of typical non-linear adaptivity criteria within debonding simulations can lead to sub-optimal remeshing results and can fail to selectively remesh the portions of the mesh in which the main mechanics of debonding are operating. As such, typical debonding simulations, and particularly those involving high adhesion of soft materials, require highly-refined initial meshes which are computationally expensive and time-consuming to utilize.

Embodiments in accordance with the present disclosure generally relate to numerical simulations of debonding and, more particularly, to criteria for adaptive remeshing in debonding simulations. For example, various embodiments described herein can enable selective refining of portions of the mesh in which damage of the cohesive-zone is actively occurring, beginning to occur, or about to occur, such that areas of high element deformation can be more accurately represented. Similarly, one or more embodiments described herein can enable selective coarsening of portions of the mesh in which damage has occurred completely and in which no further debonding is to occur, such that computational resources and time are saved.

In accordance with one or more embodiments described herein, a debonding analysis can be performed using a contact-based cohesive zone model “CZM” (e.g., a bilinear CZM or exponential CZM) within a non-linear adaptivity (“NLAD”) framework. For example, the CZM can continue a debonding failure analysis with minimal user intervention by progressively adapting the mesh at the adhesion interface as pre-defined remeshing criteria are met. In various embodiments, the adaptive remeshing can be driven by one or more of the following criteria: released energy during debonding, a damage parameter corresponding to separation of the cohesive zone, and/or a contact status of integration points associated with the contact elements of the mesh. A released energy remeshing criteria can drive selection of one or more elements for refining based on a relative change in released energy for a given solution substep with respect to released energy previously achieved in the solution history. The damage parameter can be utilized to evaluate one or more damage parameter based criteria to further drive selection of one or more elements for refining. For example, a first damage parameter based criterion can select elements for refining based on a change in damage exhibited between integration points of a given element. In another example, a second damage parameter based criterion can select elements for refining based on a contact element having both one or more integration points with a damage parameter value equal to zero and one or more integration points with a damage parameter greater than zero, which can be indicative of an onset of damage. In a further example, a third damage parameter based criterion can select elements for refining based on a change of damage parameter value in an integration point of the contact element with respect to one or more other contact elements. In an additional example, a fourth damage parameter based criterion can select elements for refining based on the damage parameter value associated with any integration point of the given contact element being larger than zero and the damage parameter value in at least one integration point of a nearby element being equal to zero, which can be indicative of an onset of damage. A coarsening criterion can drive selection of one or more elements for coarsening (e.g., the inverse of refining) based on an open contact status (e.g., a damage parameter value of one for all integration points of the element) of an associated contact element and the contact element's proximity to one or more contact elements that do not have active cohesive zone behavior, where active cohesive zone behavior can be indicative of ongoing damage or incipient damage.

Moreover, various embodiments described herein can constitute one or more technical improvements over conventional CZMs by adaptively addressing sudden element distortion in materials (e.g., soft materials) that are in proximity to an active debonding region during solution. For instance, various embodiments described herein can couple mesh density evolution with actual debonding energy release rate (e.g., independent from specific material models). As such, embodiments described herein can improve efficiency and solution stability of debonding analyses while capturing fine details of the local stress fields, deformation fields, and/or cohesive zone parameters. Additionally, one or more embodiments described herein can have a practical application by integrating novel remeshing criteria into linear or non-linear material models to facilitate the representation of small or large element deformations in a computationally efficient manner, without specialized modifications and/or requirements (e.g., without special finite elements or field formulations). Advantageously, the adaptive remeshing described herein can result in an accurate converged solution from an initial mesh having moderate to low resolution. Additionally, the CZMs described herein can model healing of a debonded region by contact driven interface closure during solution (e.g., where healing is manifested by correct contact closure).

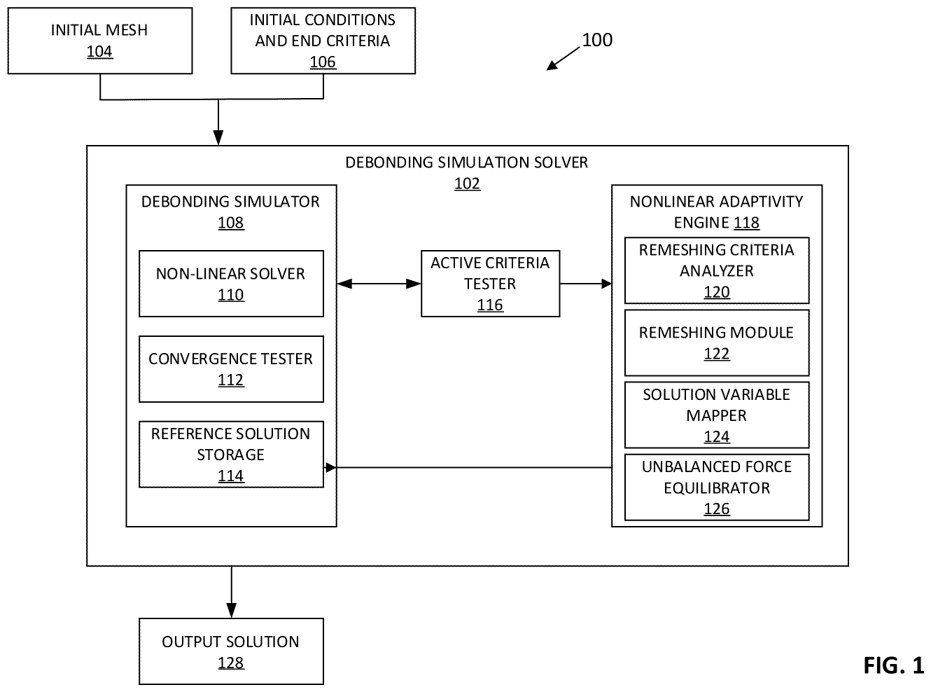

FIG. 1 illustrates a block diagram of a non-limiting example system 100 that employs a debonding simulation solver 102 for a numerical simulation of cohesive-zone debonding of an initial mesh 104. In various embodiments, the debonding simulation solver 102 can receive an initial mesh 104. Additionally, the debonding simulation solver 102 can receive one or more initial conditions and end criteria 106 for performing a numerical simulation.

The initial mesh 104 can include any geometric information of the cohesive-zone debonding problem to be solved by the debonding simulation solver 102, and can be structured with an initial average mesh size and/or element count for a finite element solver. In various embodiments, the debonding simulation solver 102 can implement a CZM that represents the cohesive zone via two cohesive surfaces held together by a traction force. The first of the cohesive surfaces can be defined as the target surface, and the other cohesive surface can be defined as the contact surface. Further, the initial mesh 104 can include target elements and contact elements; where the target elements are a type of finite element used to model the target surface, and the contact elements are a type of finite element used to model the contact surface. For example, each target element can be associated with a defined location on the target surface, and each contact element can be associated with a defined location on the contact surface. Additionally, one or more contact elements can have a corresponding target element to form a contact pair. For example, in one or more embodiments the target surface can be the cohesive surface from which the contact surface is displaced during the simulated debonding (e.g., the contact surface can translate away from the target surface, which can remain at a fixed position). In another example, the target surface and the contact surface can both be displaced away from each other during the simulated debonding (e.g., the target surface and the contact surface can both be translated in opposing directions during the debonding). The one or more initial conditions and end criteria 106 can include, but are not limited to, material properties, maximum normal contact stress, critical fracture energies, damping coefficients, and convergence criteria.

In various embodiments, the debonding simulation solver 102 can include a debonding simulator 108 configured to model debonding associated with various modes of fracture. Example modes of fracture that can be modelled by the debonding simulator 108 can include: an opening mode of fracture (e.g., mode I debonding, where two surfaces move apart normal to each other), a shearing mode of fracture (e.g., mode II debonding, where one surface glides over the other surface in the same plane), a tearing mode of fracture (e.g., mode III debonding, where the two surface move out-of-plane with each other due to shearing forces), a combination thereof, and/or the like. As shown in FIG. 1, the debonding simulator 108 can include a non-linear solver 110, a convergence tester 112, and/or reference solution storage 114.

In various embodiments, the non-linear solver 110 can utilize a finite element model to compute one or more solutions to non-linear behavior (e.g., where a lack of linear relationships exist between the modelled independent and dependent variables). For instance, the non-linear solver 110 can execute one or more numerical simulations of non-linear relationships that can include, but are not limited to: contact status (e.g., between finite elements), material non-linearity, structural non-linearity, geometric non-linearity, a combination thereof, and/or the like. Thereby, the solution determined by the non-linear solver 110 can incorporate the effects of non-linearity in the CZM. Further, the non-linear solver 110 can utilize an iterative time-stepping scheme to reach a non-linear solution that is converged at the end of the analysis. For example, the total time of the non-linear analysis can be divided into several substeps (e.g., several increments of time), where the non-linear solver 110 can integrate through multiple substeps to obtain respective convergent and equilibrated solutions (e.g., a solution can be achieved for each substep iteration). In various embodiments, a convergent solution can result when modeled residuals (e.g., the difference between externally applied forces to the modeled materials and internally generated forces) fall below a defined threshold. Additionally, an equilibrated solution can result when the sum of the external forces are nearly equal to the sum of the internal forces (e.g., where the internal forces can be a function of stress and area) within a prescribed tolerance.

In various embodiments, the convergence tester 112 can test an output (e.g., an interim solution associated with a substep) of the non-linear solver 110 to determine if the solution is convergent based on a pre-defined convergence criteria. In some embodiments, the convergence tester 112 can further determine whether the numerical simulation has converged to a final state in which the debonding analysis has completed. The convergence tester 112 can receive the one or more convergence criteria as part of the one or more initial conditions and end criteria 106. During operation of the debonding simulator 108, the convergence tester 112 can determine convergence for one or more substeps of the non-linear analysis performed by the non-linear solver 110. Further, the solution resulting from each substep, and/or various properties thereof, can be stored for future reference within the reference solution storage 114. For example, the reference solution storage 114 can store a previous substep solution on a given mesh, such as the initial mesh 104, such that the non-linear solver 110 and/or the convergence tester 112 can reference a previous substep solution (e.g., to facilitate a determination of convergence and/or initial conditions).

As the non-linear substep solver 110 iterates through a solution for the numerical simulation of debonding, one or more remeshing criteria can be activated based on, for example, a number of substeps solved. The debonding simulator 108 can pause operations of the non-linear solver 110 after one or more converged substeps so that an active criteria tester 116 can determine whether one or more remeshing criteria are active. In some embodiments, the active criteria tester 116 can receive a value denoting the current or previous substep solved within the debonding analysis performed by the debonding simulator 108, and can compare this value with one or more thresholds (e.g., which can be pre-defined and/or included within the initial conditions and end criteria 106). During substeps in which one or more remeshing criteria are not active, the active criteria tester 116 can return a signal or instructions to continue operations of the debonding simulator 108. Where one or more remeshing criteria are active for the current or previous substep solution, the active criteria tester 116 can provide the current or previous substep solution and associated mesh (e.g., initial mesh 104) to a non-linear adaptivity engine 118.

The non-linear adaptivity engine 118 can receive the current or previous substep solution and associated mesh to determine whether the associated mesh is to be dynamically refined and/or coarsened in response to changes to the solution's substep evolution. As shown in FIG. 1, the non-linear adaptivity engine 118 can include a remeshing criteria analyzer 120, remeshing module 122, solution variable mapper 124, and/or unbalanced force equilibrator 126.

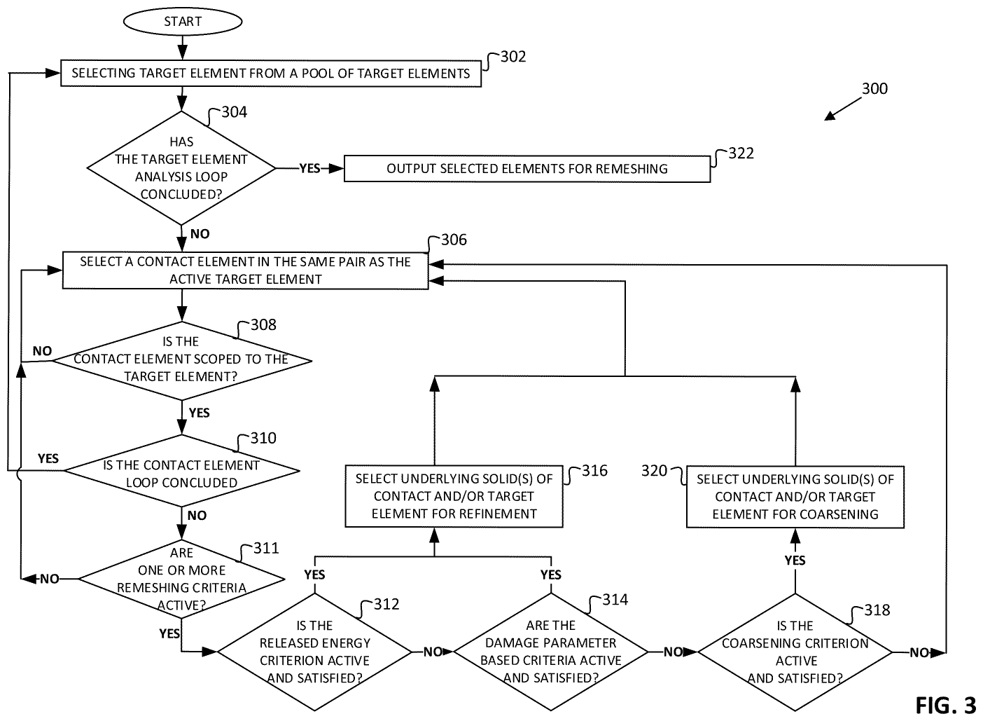

In various embodiments, the remeshing criteria analyzer 120 can analyze the provided substep solution and associated mesh to determine whether a remeshing operation is to be performed. The remeshing criteria analyzer 120 can further receive one or more instructional signals from the active criteria tester 116 denoting the one or more active criteria. For example, the remeshing criteria analyzer 120 can analyze the substep solution with reference to one or more respective threshold values associated with each active criterion. In some embodiments, the remeshing criteria analyzer 120 can receive a user-defined threshold for each criterion as part of the initial conditions and end criteria 106. The remeshing criteria analyzer 120 can perform one or more calculations using the provided solution and associated mesh to determine whether one or more remeshing criteria are satisfied (e.g., to determine whether a value, such as a released energy or damage parameter value, exceeds the associated threshold). The remeshing criteria analyzer 120 can analyze each target element and/or contact element of the associated mesh to selectively identify areas of the associated mesh that meet the active remeshing criteria and can be subject to a remeshing operation (e.g., refining or coarsening). In various embodiments, the remeshing criteria analyzer 120 can generate one or more identifiers corresponding to target elements, contact elements, associated solid elements, and/or target-contact pairings identified for remeshing. For example, the remeshing criteria analyzer 120 can perform one or more element selection process for remeshing operations in accordance with the features of FIGS. 3-13 described further herein.

In various embodiments, the remeshing module 122 can receive the one or more identifiers and selectively execute one or more refining or coarsening operations to generate a new mesh (e.g., constituting an adjustment to the mesh associated with the given substep solution). The remeshing module 122 can perform the remeshing operation according to one or more mesh control settings, which can be predefined default values inherent to the non-linear solver 110 or user-defined (e.g., provided as part of the initial conditions and end criteria 106). In various embodiments, the remeshing module 122 can adjust a maximum element volume or minimum number of elements to be included in an area of the mesh subject to the remeshing operation using a fraction based control setting (e.g., the remeshed area can be incrementally adjusted as the debonding simulation continues). Further, the remeshing module 122 can provide the newly generated mesh, the previous mesh, and/or the provided solution substep to a solution variable mapper 124.

The solution variable mapper 124 can map each variable of the provided solution substep from the previous mesh to the newly generated mesh, such that each variable of the provided solution substep is maintained during the remeshing step and information loss is prevented and/or mitigated. In some embodiments, the solution variable mapper 124 can create unbalanced forces within the newly generated mesh for the provided solution substep. such that non-physicalities are created within the mapped solution variables. In these embodiments, the unbalanced force equilibrator 126 can correct any non-physicalities and unbalanced forces in order to maintain solution integrity. The non-linear adaptivity engine 118 can provide the newly generated mesh and mapped solution substep to the debonding simulator 108 for further solution substeps and the iterative solution process can continue. The debonding simulation solver 102 can continue this iterative solution and remeshing process until an overall convergence criteria has been met or until a maximum simulated time has been reached. The convergence tester 112 can utilize the initial conditions and end criteria 106 for determination of the end state during the simulation process, and can cause the debonding simulator 108 to generate an output solution 128. The output solution 128 can include a final version of the mesh, a final state of the debonding simulation, and any additional information generated within the debonding simulation solver 102. The output solution 128 can be provided directly to a user or operator, or can be provided to a post-processing module or engine which can generate user-friendly figures and formatted data.

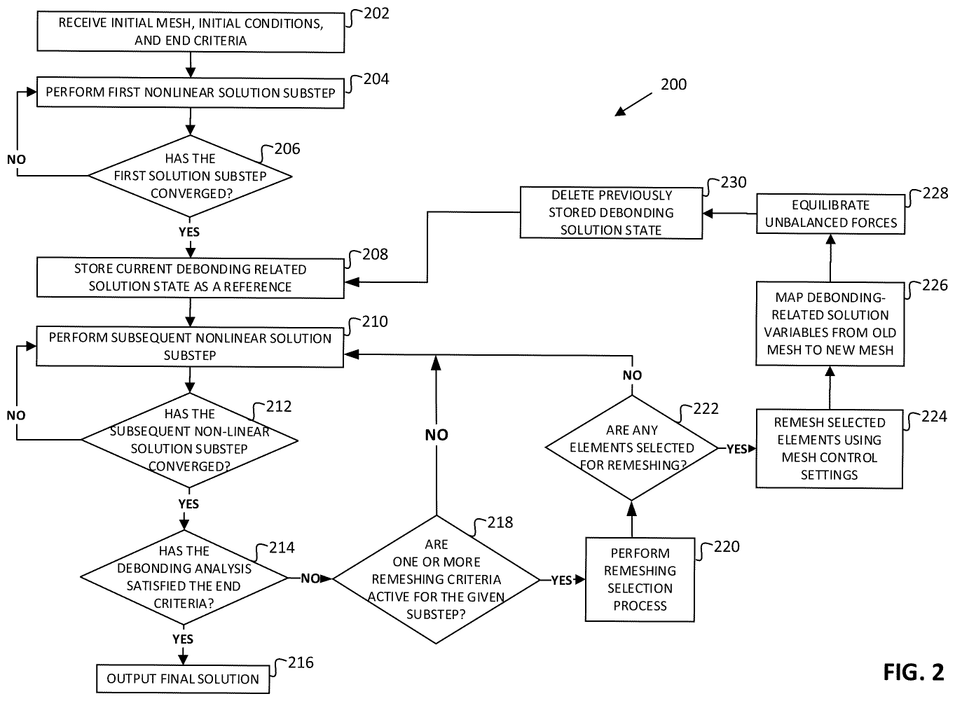

In view of the structural and functional features described above, example methods will be better appreciated with reference to FIGS. 2-12. While, for purposes of simplicity of explanation, the example methods of FIGS. 2-4, 6, and 8-11 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions can be performed that are omitted from the description.

FIG. 2 illustrates a flow diagram of a non-limiting example computer-implemented method 200 that can be implemented by the system 100 to adaptively remesh and solve a debonding simulation in accordance with one or more embodiments described herein. In various embodiments, the system 100 can implement computer-implemented method 200 to perform a plurality of solution substeps, determine active remeshing criteria, remesh based on these remeshing criteria, and output a debonding simulation solution.

At 202, the computer-implemented method 200 can include receiving an initial mesh, initial conditions, and end criteria (e.g., initial mesh 104, and initial conditions and end criteria 106). At 204, the computer-implemented method 200 can include performing a first non-linear solution substep (e.g., via the non-linear solver 110) using the data received at 202. At 206, the computer-implemented method 200 can include determining whether the first solution substep has converged (e.g., via the convergence tester 112). In accordance with one or more embodiments described herein, one or more residuals can be calculated and/or compared to convergence criteria at 206 for determining convergence. Where the first solution substep has not converged the computer-implemented method 200 can proceed back to 204 with an iteration of the first solution substep (e.g., an iterative loop can continue until the first solution substep converges). Where the first solution substep converges at 206, the computer-implemented method 200 can continue to 208. At 208, the computer-implemented method 200 can include storing (e.g., via the debonding simulator 108) the current debonding-related solution state as a reference (e.g., within the reference solution storage 114). The current debonding-related solution state stored at 208 can be utilized in comparative calculations within the computer-implemented method 200, such as residuals and released energy calculations.

At 210, the computer-implemented method 200 can include performing a subsequent non-linear solution substep (e.g., via the non-linear solver 110). At 212, the computer-implemented method 200 can include determining if the subsequent non-linear solution substep has converged (e.g., via the convergence tester 112). As with the first solution substep at 204 and 206, the convergence testing at 212 can return the computer-implemented method 200 to 210 for further iteration on the current solution substep if the current solution substep has not converged. If the current solution substep has converged at 212, the computer-implemented method 200 can continue to 214. At 214, the computer-implemented method 200 can comprise determining (e.g., via the convergence tester 112) if the solution process has satisfied the end criteria received at 202 (e.g., where one or more end criteria can be included in the initial conditions and end criteria 106). The end criteria can include, but are not limited to: a residual convergence criteria, a maximum simulated runtime, a maximum number of substeps performed, and combination thereof, and/or the like. Where the solution process has satisfied the end criteria at 214, the computer-implemented method 200 can continue at 216 to output (e.g., via the debonding simulation solver 102 and/or debonding simulator 108) a final solution (e.g., the output solution 128).

Where the solution process (e.g., a non-linear analysis performed by the non-linear solver 110) has not satisfied the end criteria at 214, the computer-implemented method 200 can continue to 218. At 218, the computer-implemented method 200 can include determining whether one or more remeshing criteria are active (e.g., via the active criteria tester 116) for the given substep. The one or more remeshing criteria can be active or inactive depending upon the number of substeps solved within the computer-implemented method 200, and each of the one or more remeshing criteria can rely upon an individual number of substeps between active states. For example, the one or more remeshing criteria can be active for defined substeps and/or defined integrals of substeps of the solution analysis, where activation status of the one or more remeshing criteria can be defined by default and/or can be pre-defined by a user of the system 100 (e.g., included in the initial conditions and end criteria 106). In accordance with various embodiments described herein, the remeshing criteria can include, for example: a released energy criterion (e.g., where mesh refining of the debonding analysis can be driven by a relative change of released energy with reference to the substep solution history), one or more damage parameter based criteria (e.g., where mesh refining of the debonding analysis can be driven by: a change in a damage parameter associated with integration points of an element, the onset of damage in an element, a change in a damage parameter associated with integration points of an element and one or more nearby elements, and/or an element's proximity to an onset of damage), and/or a coarsening criterion (e.g., where mesh coarsening of the debonding analysis can be driven by a complete debonding indicator, such as a maximum damage parameter value, and/or the element's proximity to a simultaneous refining operation implemented on the mesh). Where no remeshing criteria are active at 218, the computer-implemented method 200 can continue at 210 with a subsequent solution substep, and a further analysis loop of the computer-implemented method 200 can continue.

Where one or more of the remeshing criteria are active at 218, the computer-implemented method 200 can continue to 220. At 220, the computer-implemented method 200 can comprise performing a remeshing selection process (e.g., via the remeshing criteria analyzer 120). The remeshing selection process performed at 220 can include testing each active remeshing criteria against each contact element paired to each target element. It should be noted, however, that the testing can be performed only on specific mesh areas, or specific elements, without departing from the scope of this disclosure. The remeshing selection process can include performing calculations involving released energy, damage parameter values, and/or any additional cohesive-zone based calculation. For example, the remeshing selection process performed at 220 can be performed by the remeshing criteria analyzer 120 in accordance with the features of FIG. 3 described further herein. At 222, the computer-implemented method 200 can include determining (e.g., via the remeshing criteria analyzer 120) whether one or more elements have been selected for remeshing (e.g., for refining or coarsening). Where no elements have been selected for remeshing (e.g., where none of the active remeshing criteria are satisfied), the computer-implemented method 200 can proceed back to 210 with a subsequent solution substep (e.g., via the non-linear solver 110), and a further analysis loop of the computer-implemented method 200 can continue.

Where one or more elements have been selected for remeshing at 220, the computer-implemented method 200 can continue to 224. At 224, the computer-implemented method 200 can comprise remeshing (e.g., via the remeshing module 122) the one or more selected elements of the given mesh in accordance with one or more defined mesh control settings. The defined mesh control settings can be predetermined, or default, values for tuning and/or adjusting a mesh. In one or more embodiments, the defined mesh control settings can be received at 202. The remeshing at 224 can include: refining the one or more selected elements or areas of the given mesh, coarsening the one or more selected elements or areas of the given mesh, or both refining and coarsening respective elements or respective areas of the given mesh. At 226, the computer-implemented method 200 can include mapping (e.g., via the solution variable mapper 124) one or more debonding-related solution variables from the old mesh to the new mesh generated at 224. The mapping at 226 can enable execution of further solution substeps without adjustment to the solution process or further user input, such that the newly generated mesh can be utilized in the computer-implemented method 200 moving forward.

At 228, the computer-implemented method 200 can include equilibrating any unbalanced forces (e.g., via the unbalanced force equilibrator 126) resulting from mapping at 226. For example, the equilibration of unbalanced forces at 228 can correct any non-physicalities created during mapping at 226. At 230, the computer-implemented method 200 can include deleting (e.g., via the debonding simulator 108) the previously stored debonding solution state, as the previously stored debonding solution state corresponds to the old mesh utilized in the previous simulation substep. Further, the computer-implemented method 200 can proceed back to 208 and can include storing (e.g., via the debonding simulator 108) the current debonding-related solution state as a reference for further iterations, such that the stored reference corresponds to the new mesh (e.g., mesh generated as a result of the remeshing operations, such as refining and/or coarsening selected elements). The computer-implemented method 200 can continue looping through solution substeps and remeshing until the end criteria are satisfied at 214 and the final solution is output at 216.

FIG. 3 illustrates a flow diagram of a non-limiting example computer-implemented method 300 that can be implemented by the system 100 to select elements for one or more remeshing operations based on one or more remeshing criteria in accordance with one or more embodiments described herein. In various embodiments, the system 100 can implement computer-implemented method 300 within the active criteria tester 116 and remeshing criteria analyzer 120. Further, the computer-implemented method 300 can be at practiced at 220 of the computer-implemented method 200, such that the determination of active remeshing criteria and selection of elements for remeshing is performed via the computer-implemented method 300.

At 302, the computer-implemented method 300 can include selecting a target element from a pool of target elements (e.g., where the pool of target elements includes target elements from a given mesh and/or from a designated area of the given mesh). For example, the target element selected at 302 can be the first, or subsequent, target element of a non-linear solution analysis loop applicable to target elements of the given mesh. The selected target element can be used in further determinations, and can provide information on a paired surface. At 304, the computer-implemented method 300 can comprise determining whether the target element analysis loop has concluded. For example, the computer-implemented method 300 can determine whether each target element has been analyzed by the computer-implemented method 300 for the given substep (e.g., whether the selected target element has been previously evaluated with respect to one or more remeshing criteria). Where the target element analysis loop has not concluded, the computer-implemented method 300 can proceed to 306.

At 306, the computer-implemented method 300 can include selecting a contact element in the same pair as the selected target element At 308, the computer-implemented method 300 can include determining whether the selected contact element is scoped to the selected target element, such that the contact element is defined to interact with the target element through one or more cohesive interactions (e.g., one or more bonding mechanisms that simulate the intermolecular forces that hold materials together). Where the selected contact element is not scoped to the selected target element. the computer-implemented method 300 can proceed back to 306 for selection of another contact element for analysis. Where the selected contact element is scoped to the selected target element, the computer-implemented method 300 can proceed to 310.

At 310, the computer-implemented method 300 can comprise determining whether the contact element analysis loop has concluded. For example, the remeshing criteria analyzer 120 can determine whether the scoped contact element has been previously analyzed with respect to the one or more active remeshing criteria for the given substep. Where the contact element analysis loop has concluded (e.g., where each of the scoped contact elements have been analyzed with respect to the one or more active remeshing criteria for the given substep solution), the computer-implemented method 300 can proceed back to 302 for the selection of another target element. Where the contact element analysis loop has not concluded, the computer-implemented method 300 can proceed to 311.

At 311, the computer-implemented method 300 can comprise determining whether one or more of the remeshing criteria are active with respect to the selected contact element. In accordance with one or more embodiments described herein, an indication as to whether one or more of the remeshing criteria are active can be provided by the active criteria tester 116 at 218 of computer-implemented method 200. For example, remeshing criteria that are deactivated for the given substep can inherently be deactivated for the selected contact element. Whereas remeshing criteria that are active for the given substep may or may not be active regarding the selected contact element currently being analyzed by the contact element analysis loop. For instance, one or more of the remeshing criteria can be selectively applied to designated areas of the mesh in accordance with one or more preference settings that can be included in the initial conditions and end criteria 106 (e.g., the preference settings can be user defined and can enable a user of the system 100 to further tailor the adaptive remeshing operations described herein to efficiently direct computational resources towards areas of the debonding simulation where accuracy is prioritized). In another instance, remeshing criteria active for the given substep can (e.g., by default) also be active for the selected contact element.

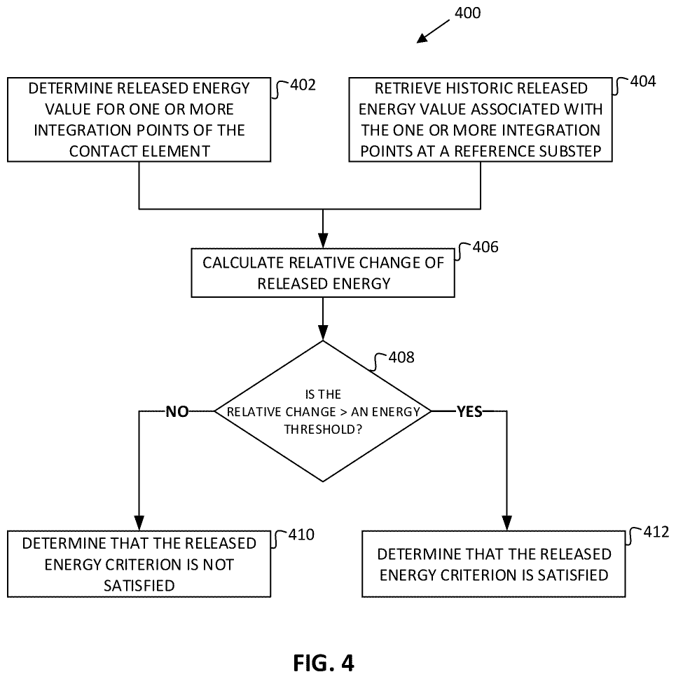

At 312, the computer-implemented method 300 can comprise determining whether a released energy criterion is active and satisfied. In accordance with one or more embodiments described herein, an indication as to whether the released energy criterion is active can be provided by the active criteria tester 116 at 218 of computer-implemented method 200. For instance, one or more of the remeshing criteria may be activated or deactivated by a user of the system 100 (e.g., via control of the active criteria tester 116).

Where the released energy criterion is active, determining whether the released energy criterion is satisfied can include a comparison of a computed value of relative change of released energy to a pre-defined energy threshold value. The determining whether an active released energy criterion is satisfied at 312 can be performed in accordance with the features of FIG. 4 described further herein. For example, the computed released energy value can be a relative change of released energy with reference to the solution history. For instance, the released energy associated with one or more previous substeps (e.g., as stored in the reference solution storage 114) can be referenced in determining the relative change of released energy, which can be compared to the energy threshold. Where the released energy criterion is not both active and satisfied, the computer-implemented method 300 can continue to 314. Where the released energy criterion is both active and satisfied, the computer-implemented method 300 can proceed to 316.

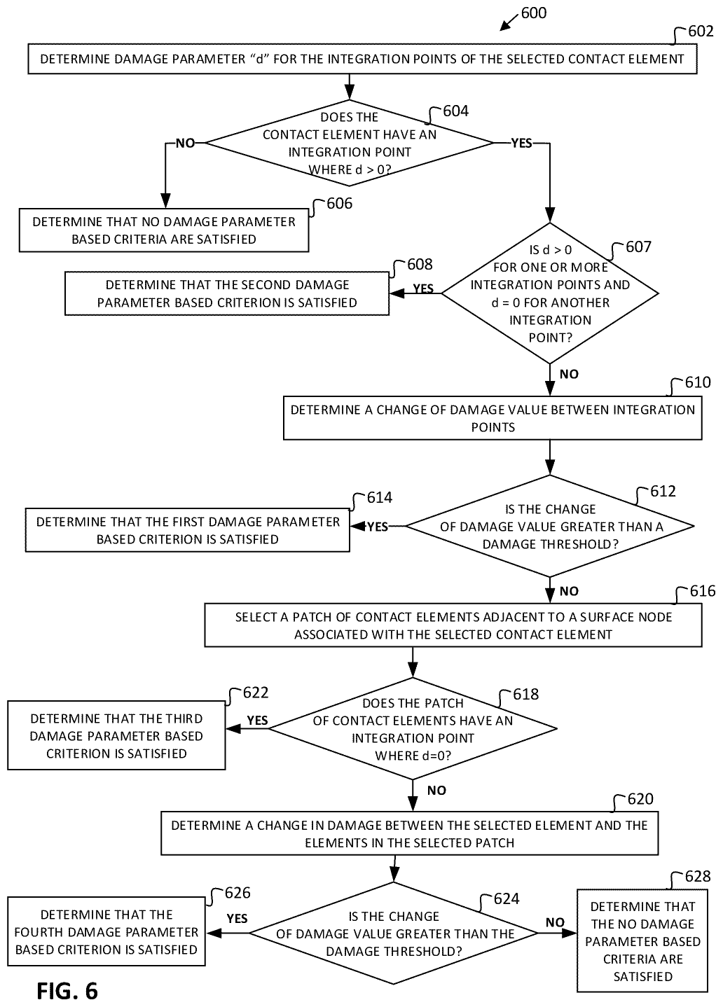

At 314, the computer-implemented method 300 can comprise determining whether one or more of the damage parameter based criteria are active and satisfied. In accordance with one or more embodiments described herein, an indication as to whether one or more of the damage parameter based criteria are active can be provided by the active criteria tester 116 at 218 of computer-implemented method 200. Where one or more of the damage parameter based criteria are active, determining whether one or more of the damage parameter based criteria are satisfied can include computing damage parameter values associated with one or more integration points of an element. In various embodiments, determining whether one or more of the damage parameter based criteria are satisfied at 314 can be performed in accordance with the features of FIGS. 6, and 8-10 described further herein. For example, satisfaction of one or more of the computed damage parameter based criteria can be indicative of damage to a partially debonded element, an onset of damage within an element, and/or proximity to an element associated with an onset of damage. Where one or more of the damage parameter based criteria are both active and satisfied, the computer-implemented method 300 can proceed to 316. Where none of the damage parameter based criteria are both active and satisfied, the computer-implemented method 300 can proceed to 318.

At 316, the computer-implemented method 300 can comprise selecting one or more solid elements underlying (e.g., associated with) the selected target element and/or one or more solid elements underlying (e.g., associated with) the selected contact element for refining. For example, the solid element can be a finite element used to discretize the bulk materials. In accordance with one or more embodiments described herein, the elements selected at 316 can be refined by the remeshing module 122 at 224 of the computer-implemented method 200.

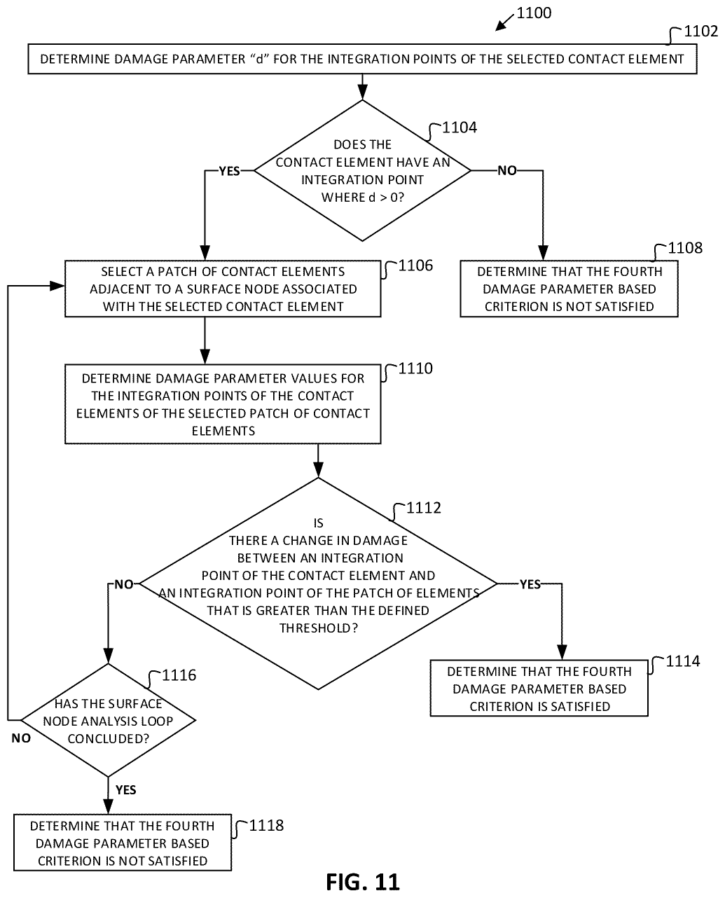

At 318, the computer-implemented method 300 can comprise determining whether the coarsening criterion is active and satisfied. In accordance with one or more embodiments described herein, an indication as to whether the coarsening criterion is active can be provided by the active criteria tester 116 at 218 of computer-implemented method 200. Where the coarsening criterion is active, determining whether the coarsening criterion is satisfied can include determining the contact status of nearby contact elements. For example, the determining whether the coarsening criterion is satisfied at 318 can be performed in accordance with the features of FIG. 11 described further herein. The evaluation of the coarsening criterion at 318 can identify contact elements that have fully debonded. For instance, contact elements associated with a damage parameter value indicative of complete debonding (e.g., a value of about 1) can satisfy the coarsening criterion where the contact element is also distanced from one or more instances of refining in the mesh

Where the coarsening criterion is active and satisfied, the computer-implemented method 300 can continue to 320. At 320, the computer-implemented method 300 can include selecting one or more solid elements underlying (e.g., associated with) the contact element and/or one or more solid elements underlying (e.g., associated with) the target element for coarsening. In accordance with one or more embodiments described herein, the elements selected at 320 can be coarsened by the remeshing module 122 at 224 of the computer-implemented method 200.

Where the coarsening criterion is not both active and satisfied, the computer-implemented method 300 can continue back to 306, where selection of a new contact element can be performed. Further, the computer-implemented method 300 can continue back to 306 following selecting elements for refinement or coarsening at 316 and 320.

As shown in FIG. 3, the remeshing criteria analyzer 120 can perform multiple analysis loops during the remeshing selection process implemented at 220 of the computer-implemented method 200 in accordance with the computer-implemented method 300. For example, the computer-implemented method 300 can include a contact element analysis loop comprising: selecting contact elements of the same pair as a given target element, and evaluating whether a remeshing operation (e.g., a refining operation or a coarsening operation) is triggered for each contact element scoped to the given target element. The selection and evaluation of contact elements can repeat within the contact element analysis loop until each contact element in the same pair of the given target element is analyzed.

Further, the target element analysis loop can comprise: selecting a target element, conducting the contact element analysis loop, and then selecting a new target element until each target element from a pool of target elements has been analyzed. In various embodiments, the target element pool can include each target element in the given mesh or specifically designated target elements within the mesh. Once the target element analysis loop has concluded, the computer-implemented method 300 can continue to 322. At 322, the computer-implemented method 300 can include outputting the selected elements for remeshing (e.g., the elements selected at 316 or 320). For example, the outputting at 322 can include outputting one or more element identifiers associated with the solid elements, the contact elements, and/or the target elements selected at 316 or 320. The elements selected for remeshing can include elements to be refined and/or elements to be coarsened. In various embodiments, no remeshing criteria may be active and satisfied; thereby resulting in a lack of elements selected for remeshing (e.g., where the computer-implemented method 300 can output an indication of such at 322 to inform the determination at 222 of the computer-implemented method 200).

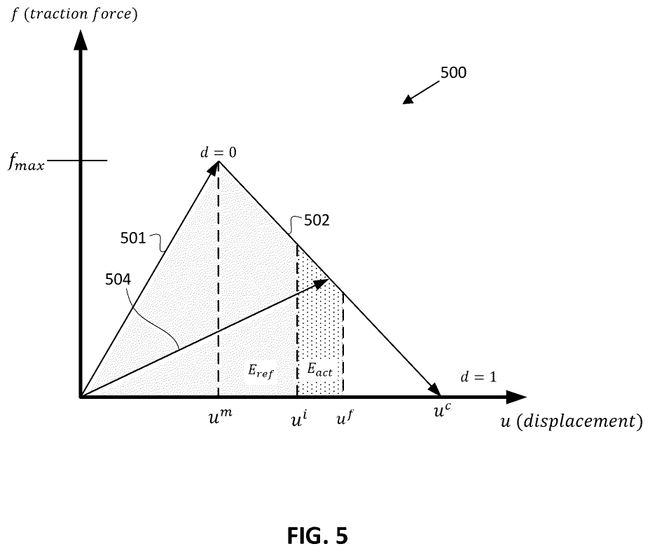

FIG. 4 illustrates a flow diagram of a non-limiting example computer-implemented method 400 that can be implemented by the system 100 (e.g., by the debonding simulation solver 102 via the remeshing criteria analyzer 120) to calculate a relative change of released energy for one or more integration points of a contact element and determine whether to select any elements for refining. The computer-implemented method 400 can be employed (e.g., via the remeshing criteria analyzer 120) at 312 of FIG. 3 to determine (e.g., via the remeshing criteria analyzer 120) whether the released energy criterion is satisfied. Various features of the computer-implemented method 400 are described with reference to an example cohesive material behavior relation shown in FIG. 5.

FIG. 5 illustrates a diagram of a non-limiting example graph 500 depicting a bilinear traction force-displacement relationship that can characterize cohesive zone material behavior in accordance with one or more embodiments described herein. While the bilinear force-displacement relationship shown in graph 500 is used to exemplify the evaluation of the released energy criterion with respect to a linear-elastic cohesive zone material, embodiments in which the remeshing operations and/or remeshing criteria (e.g., the one or more released energy, damage parameter, and/or coarsening criteria) can be applied to all kind of cohesive zone materials (e.g., exponential). Also, bulk materials characterized by a variety of behaviors (e.g., elastic, elasto-plastic, hyper-elastic, viscous effects, creep effects, thermal effects, static behavior, and/or transient behavior) are also envisaged herein.

Line 501 depicts a traction force “f” increasing linearly as the two modeled surfaces start to separate from each other. This force reaches a maximum value “fₘₐₓ”, thereby defining a first displacement value “u^{m}” (e.g . . . displacement at maximum force), after which the force starts to decrease linearly as further displacement “u” ensues until a complete debonding has occurred (e.g., at a second displacement value “u^{c}”). As shown in FIG. 5, a damage parameter “d” can initiate at the first displacement value u^{m} (e.g., where maximum traction force exists) and increase until complete debonding has occurred (e.g., d=0 at u^{m} and d=1at u^{c}, indicating complete debonding and zero traction force). Thereby, in one or more embodiments described herein, the contact status of an element can be at least partially characterized by a damage parameter value ranging between 0) and 1. Thus, line 502 depicts a damage progression referred to as the softening part of the curve representing the force-displacement relationship. Line 504 can depict any unloading and subsequent reloading that may occur after debonding (e.g., which can be exhibited in a linear elastic manner, as shown in graph 500).

The area under lines 501 and 502 can represent energy released due to debonding (e.g., critical fracture energy). As shown in graph 500, the energy reference area “E_{ref}” can represent cumulative released energy associated with previous substeps of the non-linear solution analysis (e.g., can be associated with the solution history). Also, the current released energy area “E_{act}” can represent released energy associated with the current substep, where the current substep characterizes debonding associated with displacement between an initial displacement value “uⁱ” (e.g., the final displacement value of the last substep) and a final displacement value “u^{f}” (e.g., a displacement value resulting from the solution of the given substep).

Referring back to FIG. 4, at 402, the computer-implemented method 400 can include determining a released energy value for one or more integration points of a contact element at the current substep. The current substep can be a solution substep solved by the debonding simulator 108 and non-linear substep solver 110, such that a converged substep solution is utilized in the released energy value determination. The determination at 402 can be performed using, for example, a released energy formula (e.g., such as computing normal critical fracture energy for a mode I debonding, computing tangential critical fracture energy for a mode II debonding, and/or computing total fracture energy for a mixed mode debonding) or through calculation of an area under a traction force-displacement curve (e.g., as shown in FIG. 5). For instance, E_{act} can be computed (e.g., via the remeshing criteria analyzer 120) at 402. At 404, the computer-implemented method 400 can include retrieving a released energy value for one or more integration points of the selected contact element at a stored reference substep solution (e.g., from the reference solution storage 114). The released energy value at the stored reference substep solution can be calculated in a similar manner to the released energy value determined at 402, or can be previously performed and stored as part of the stored reference substep solution. For instance, E_{ref} can be retrieved (e.g., via the remeshing criteria analyzer 120) at 404.

At 406, the computer-implemented method 400 can include calculating a relative change of released energy “ΔE” as a function of the released energy values obtained at 402 and 404. For example, the computer-implemented method 400 can utilize Equation 1 for determining the relative change of released energy.

$$Δ E = \frac{{E}_{act} - {E}_{ref}}{{E}_{ref}} \qquad ( 1 )$$

At 408, the computer-implemented method 400 can include comparing the relative change of released energy to an energy threshold (e.g., representing a percentage change in released energy from the stored reference substep solution). In various embodiments, the energy threshold can be user-defined and provided to the computer-implemented method 400 (e.g., as part of the initial conditions and end criteria 106). Further, the selection of the energy threshold value is dependent on the cohesive zone material (e.g., dependent on the properties of the cohesive zone material). For example, where the slope of line 501 is fixed in the bilinear cohesive zone material 500, and the slope of line 502 can be either steep or shallow depending on the rate of damage (e.g., where steep indicates rapid rate of damage and shallow indicates a slow rate of damage); a small energy threshold can be suited for the steep slope and a larger energy threshold can be suited for the shallow slope to allow remeshing changes at critical regions of damage. As the energy threshold value increases, refining of the elements can become increasingly localized. Conversely, smaller values of the energy threshold can produce larger refining areas.

Where the relative change of released energy is less than or equal to the energy threshold at 408, the computer-implemented method 400 can determine at 410 that the released energy criterion is not satisfied. Conversely, where the relative change of released energy is greater than the value of the energy threshold at 408, the computer-implemented method 400 can determine that the released energy criterion is satisfied. For example, the released energy criterion can be satisfied where at least one of the integration points of the selected contact element is associated with a change in released energy that is greater than the energy threshold. As such the released energy criterion can couple mesh density evolution with actual debonding energy release rate, and the energy threshold can be tailored to adjust the localization of the refining operation (e.g., by adjusting the scope of element selection).

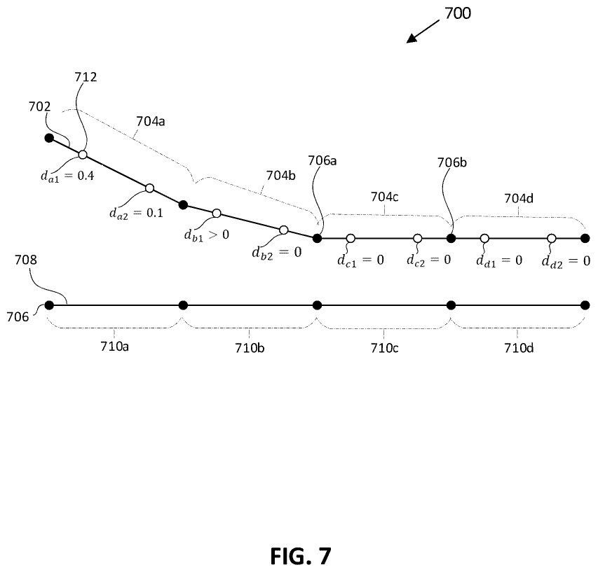

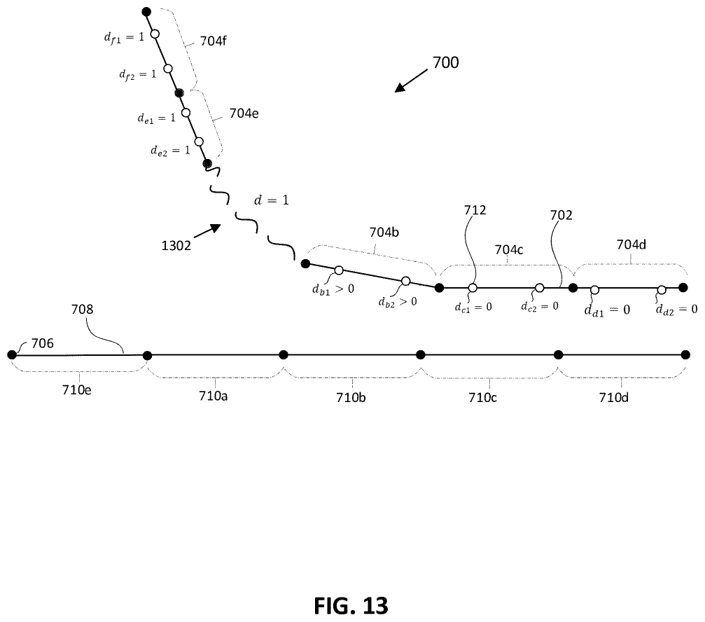

FIG. 6 illustrates a flow diagram of a non-limiting example computer-implemented method 600 that can be implemented by the system 100 (e.g., by the debonding simulation solver 102 via the remeshing criteria analyzer 120) to calculate a damage parameter value associated with one or more integration points of the contact element. The computer-implemented method 600 can be employed (e.g., via the remeshing criteria analyzer 120) at 314 of FIG. 3 to determine (e.g., via the remeshing criteria analyzer 120) whether one or more of the damage parameter based criteria are satisfied. Various features of the computer-implemented method 600 are described with reference to example surfaces of a cohesive zone shown in FIG. 7. In accordance with various embodiments described herein, FIGS. 7 and 13 are simplified (e.g., for purposes of clarity) two-dimensional representations of cohesive zone modelling that can be embodied by substantially more complex meshes and/or complex simulations (e.g., including three-dimensional cohesive zone models).

In various embodiments, a first damage parameter based criterion can be based on the change of damage between integration points of the same contact element, and can be indicative of damage to a contact element substantial enough to trigger a refining operation of the mesh (e.g., refining the initial mesh 104, or the mesh resulting from a previous substep). A second damage parameter based criterion can be based on the damage parameter value amongst various integration points of the contact element, and can be indicative of an onset of damage to the contact element. Further, an identification of an onset of damage can trigger a refining operation that includes the contact element and/or solid elements associated therewith. A third damage parameter based criterion can be based on a contact element's proximity to a contact element associated with an onset of damage. Where the contact element is proximate (e.g., adjacent) to another contact element that is exhibiting indications of the onset of damage (e.g., where the second damage parameter based criterion is satisfied), the contact element can satisfy the third damage parameter based criterion and can be subject to a refining operation. A fourth damage parameter based criterion can be based on the change of damage between the contact element and one or more nearby elements (e.g., elements in proximity to the contact element).

In various embodiments, each of the damage parameter based criteria can be active for analysis at 314, and the remeshing criteria analyzer 120 can apply computer-implemented method 600 to determine which, if any, of the damage parameter based criteria are satisfied. At 602, the computer-implemented method 600 can comprise determining (e.g., via the remeshing criteria analyzer 120) a damage parameter “d” value for a plurality of integration points of the contact element selected at the current substep. In various embodiments, the damage parameter value can represent degradation of the modeled materials and/or can be a function of debonding between the target surface and the contact surface. For example, the damage parameter can be computed for bilinear cohesive laws and/or exponential cohesive laws.

The current substep can be a solution substep solved by the debonding simulator 108 and non-linear substep solver 110, such that a converged substep solution is utilized in the damage parameter determination. The damage parameter determined at 602 can range from, for example, about 0 (e.g., indicating that the integration point is at maximum traction force and debonding has not occurred) to about 1 (e.g., signifying that the integration point has fully debonded and the traction force has reached a value of zero). In various embodiments, the damage progression can follow a linear profile on a traction force-displacement curve from the onset of damage to full debonding (e.g., as shown in FIG. 5). However, the damage progression can follow a higher-order or non-linear profile during debonding without departing from the scope of this disclosure.

For example, FIG. 7, illustrates an example cohesive zone 700 that includes an example contact surface 702 comprising a plurality of example contact elements 704 (e.g., a first example contact element 704a, a second example contact element 704b, a third example contact element 704c, and/or a fourth example contact element 704d) defined by a plurality of example surface nodes 706 (e.g., represented by black circles in FIG. 7). Additionally, the example cohesive zone 700 includes an example target surface 708 comprising a plurality of example target elements 710 (e.g., a first example target element 710a, a second example target element 710b, a third example target element 710c, and/or a fourth example target element 710d) defined by the plurality of example surface nodes 706. Each of the example contact elements 704 can include a plurality of example integration points 712. For instance, each example contact element 704 can include two or more example integration points 712 (e.g., represented by white circles in FIG. 7).

FIG. 7 exemplifies the damage parameter value determination performed at for each of the example integration points 712. For example, FIG. 7 depicts example damage parameter values determined at 602 for each of the example integration points, where the damage parameter value d is formatted as “d_{xy}” with “x” indicating the associated example contact element 704 and “y” indicating the associated example integration point 712. For instance, “dₐₗ” represents the damage parameter value for a first example integration point 712 of the first example contact element 704a.

At 604, the computer-implemented method 600 can comprise determining whether the contact element has an integration point where the damage parameter value is greater than zero. Where the contact element does not have an integration point with a damage parameter value greater than zero, the computer-implemented method 600 can proceed to 606. Where the contact element does have at least one integration point with a damage parameter value greater than zero, the computer-implemented method 600 can proceed to 607.

For example, with reference to the example cohesive zone 700 of FIG. 7, the third example contact element 704c and the fourth example contact element 704d have damage parameter values of zero associated with all of their respective example integration points 712 (e.g., d_{c1}=0, d_{c2}=0, d_{d1}=0, and d_{d2}=0); thus, the computer-implemented method 600 can proceed to 606 when analyzing the third example contact element 704c and the fourth example contact element 704d. Additionally, the first example contact element 704a and the second example contact element 704b each have at least one example integration point 712 with a damage parameter value greater than zero (e.g., da₁=0.4, dₐ₂=0.1, and d_{b1}>0); thus, the computer-implemented method 600 can proceed to 607 when analyzing the first example contact element 704a and the second example contact element 704b.

At 606, the computer-implemented method 600 can comprise determining that no damage parameter based criteria are satisfied. At 607, the computer-implemented method 600 can comprise determining whether the damage parameter value for one or more of the integration points of the contact element is greater than zero while being equal to zero for one or more other integration points of the contact element. For example, the computer-implemented method 600 can reference each of the damage parameter value determinations made at 602. Where at least one integration point has a damage parameter value of zero while one or more other integration points of the same contact element have a non-zero damage parameter value, the computer-implemented method 600 can proceed to 608. Where all the integration points of the contact element have a value greater than zero, the computer-implemented method 600 can proceed to 610.

At 608, the computer-implemented method 600 can comprise determining that the second damage parameter based criterion is satisfied. For example, the presence of one or more integration points with a damage parameter value of zero along with one or more integration points with a damage parameter value greater than zero can be indicative of an onset of damage. For example, with reference to the example cohesive zone 700 of FIG. 7, the second example contact element 704b is characterized by a first example integration point 712 having a damage parameter value greater than zero (e.g., d_{b1}>0) along with a second example integration point 712 having a damage parameter value equal to zero (e.g., d_{b2}=0). Thus, the computer-implemented method 600 can determine that the second example contact element 704b meets the second damage parameter based criterion and exhibits properties associated with the onset of damage. In various embodiments, the second example contact element 706b, and/or the one or more underlying solid elements associated therewith, would be selected for refining at 316 of the computer-implemented method 300 in accordance with the damage parameter based criteria evaluation performed by the computer-implemented method 600.

At 610, the computer-implemented method 600 can comprise determining a change of damage parameter value between integration points of the selected contact element. For example, the change of damage value “Δd” can be computed in accordance with Equation 2 below.

$$Δ d = \vert {d}_{intpt = k} - {d}_{intpt = l} \vert \qquad ( 2 )$$

Where “dᵢₙₜₚₜ₌ₖ” represents the damage parameter value of one integration point within the contact element, and “dᵢₙₜₚₜ₌ₗ” represents the damage parameter value of another integration point within the contact element. In various embodiments, the damage parameter value at each integration point can be compared to the damage parameter value at all other integration points of the contact element, where indices “k” and “l” loop over all integration points of the element. For instance, the damage parameter value of each integration point of the contact element can be computed; where dᵢₙₜₚₜ₌ₖ can be the integration point with the largest damage parameter value, and dᵢₙₜₚₜ₌ₗ can be the integration point with the smallest damage parameter value.

For example, with reference to the example cohesive zone 700 of FIG. 7, each example integration point 712 of the first example contact element 704a has a damage parameter value greater than zero; thus, the computer-implemented method 600 can proceed to 610 in analyzing the first example contact element 704a. Further, the change of damage value can be a function of the damage parameter values of the first example integration point 712 (e.g., dₐ₁=0.4) and the second example integration point 712 (e.g., dₐ₂=0.1) of the first example contact element 704a. For instance, the change of damage parameter value for the first example contact element 704a is 0.3.

At 612, the computer-implemented method 600 can comprise determining whether the change of damage value is greater than a pre-defined damage threshold. The damage threshold can be a default value or can be defined by a user of the system 100 (e.g., the damage threshold can be included in the initial conditions and end criteria 106). For example, the damage threshold can have a value of 0.1, thereby representing a 10 percent change in damage between integration points of the selected contact element. In one or more embodiments, an example reasonable damage threshold can have a value ranging from, for instance, greater than or equal to about 0.1 and less than or equal to about 0.5. The maximum range for the damage threshold can be between greater than 0) and 1.0, where the minimal value can result in selecting every contact element with a damage parameter value larger than zero and the maximal value can result in no selection. Additionally, the damage threshold can be material dependent and selected based on the debonding simulation parameters.

Where the change of damage value is greater than the damage threshold, the computer-implemented method 600 can proceed 614 and determine that the first damage parameter based criterion is satisfied. For example, with reference to the example cohesive zone 700 of FIG. 7, the computer-implemented method 600 can determine that the first example contact element 704a satisfies the first damage parameter based criterion, where the damage threshold is 0.1. For instance, the marked change in damage between example integration points 712 can be indicative of an amount of damage that triggers a remeshing operation. In various embodiments, the first example contact element 704a and the one or more underlying solid elements associated therewith, and/or the scoped target element and the one or more underlying solid elements associated therewith, would be selected for refining at 316 of the computer-implemented method 300 in accordance with the damage based criteria evaluation performed by the computer-implemented method 600.

Where the change of damage value is less than or equal to the damage threshold, the computer-implemented method 600 can proceed 616. For example, the contact element can be exhibiting damage, but not enough change in damage between integration points to merit a remeshing operation in accordance with the standards defined by the damage threshold.

At 616, the computer-implemented method 600 can comprise selecting a patch of contact elements adjacent to a surface node associated with the selected contact element. The patch of contact elements can include one or more contact elements, other than the selected contact element, that at least partially surround the designated surface node. In one or more embodiments, the designated surface node can be a surface node that at least partially defines a boundary of the selected contact element; thereby, the patch of contact elements can include one or more contact elements within a close proximity (e.g., adjacent) to the selected contact element in the mesh.

For example, with reference to the example cohesive zone 700 of FIG. 7, when analyzing the third example contact element 704c; a first example surface node 706a can be referenced by the computer-implemented method 600 to select the second example contact element 704b as included in the patch of contact elements (e.g., where the first example surface node 706a at least partially defines the bounds of the third example contact element 704c). Likewise, when analyzing the fourth example contact element 704d; a second example surface node 706b can be referenced by the computer-implemented method 600 to select the third example contact element 704c as included in the patch of contact elements (e.g., where the second example surface node 706b at least partially defines the bounds of the fourth example contact element 704d). Conversely, when analyzing the third example contact element 704c; a second example surface node 706b can be referenced by the computer-implemented method 600 to select the fourth example contact element 704d as included in the patch of contact elements (e.g., where the second example surface node 706b at least partially defines the bounds of the third example contact element 704c).

At 618, the computer-implemented method 600 can comprise determining whether the selected patch of contact elements have an integration point with a damage parameter value equal to zero. For example, the damage parameter value for each integration point of the one or more contact elements of the selected patch can be determined in accordance with the features of 602. Where at least one integration point of one or more of the contact elements of the selected patch of contact elements has a damage parameter value equal to zero, the computer-implemented method 600 can proceed to 622. Where none of the integration points of the one or more contact elements of the selected patch of contact elements has a damage parameter value equal to zero, the computer-implemented method 600 can proceed to 620.

At 622, the computer-implemented method 600 can determine that the third damage parameter based criterion is satisfied, thereby indicating that the selected contact element is proximate to another contact element exhibiting the onset of damage. For example, with reference to the example cohesive zone 700 of FIG. 7, when analyzing the first example contact element 704a; the second example contact element 704b (e.g., included in the selected patch of contact elements) has an example integration point 712 with a damage parameter value equal to zero (e.g., d_{b2}=0). Therefore, the first example contact element 704a can satisfy the third damage parameter based criterion. For instance, the second example contact element 704b is exhibiting the onset of damage (e.g., as described further herein), and the first example contact element 704a is proximate to said onset of damage. In various embodiments, the first example contact element 704a and/or one or more underlying solid element associated therewith, and/or the scoped target element and/or one or more underlying solid elements associated therewith, can be selected for refinement at 316 of the computer-implemented method 300 in accordance with the damage parameter based criteria evaluation performed by the computer-implemented method 600.

At 624, the computer-implemented method 600 can comprise determining whether the change of damage value between the damage associated with an integration point of the selected contact element and the damage associated with an integration point from the selected patch of contact elements is greater than the defined damage threshold. Where the change of damage value is greater than the damage threshold, the computer-implemented method 600 can proceed to 626. Where the change of damage value is less than or equal to the damage threshold, the computer-implemented method 600 can proceed to 628. At 626, the computer-implemented method 600 can comprise determining that the fourth damage parameter based criterion is satisfied.

At 628, the computer-implemented method 600 can comprise determining that no damage parameter based criteria are satisfied, thereby indicating that the selected contact element need not be selected for refinement remeshing.

In various embodiments, the computer-implemented method 600 can repeat features 606 and 608-612 for with respect to each surface node associated with the selected contact element. For example, where the boundary of the contact element is defined by a plurality of surface nodes, the computer-implemented method 600 can select and evaluate multiple patches of contact elements, with each respective patch selected with respect to a respective surface node associated with the contact element (e.g., as shown in FIG. 11 and described further herein).

In various embodiments, one or more of the damage parameter based criteria can be inactive while one or more other damage parameter based criteria can be active. Depending on which damage parameter based criteria are active, the remeshing criteria analyzer 120 can apply computer-implemented method 800, 900, 1000, or 1100 to analyze the contact element with respect to individual damage parameter based criterion.

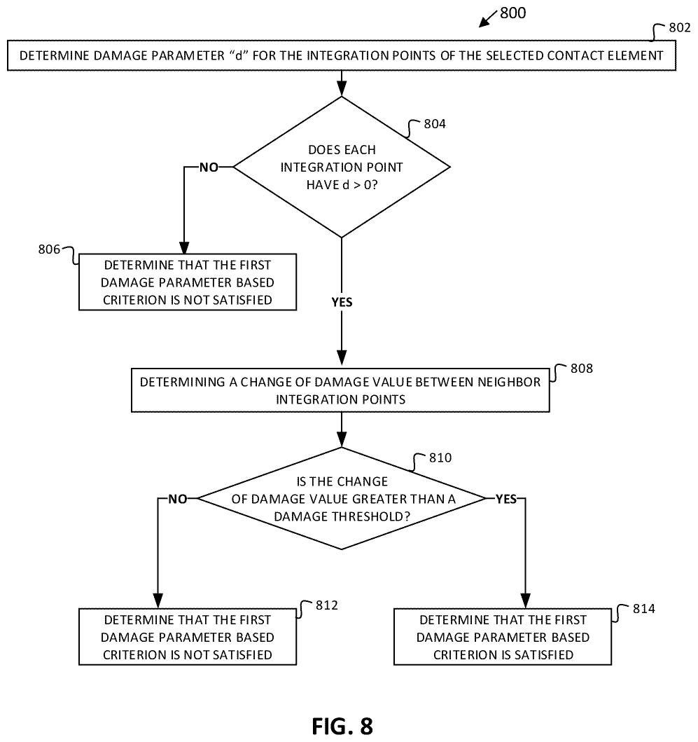

FIG. 8 illustrates a flow diagram of a non-limiting example computer-implemented method 800 that can be implemented by the system 100 to determine whether the first damage parameter based criterion is satisfied. The computer-implemented method 800 can be employed at 314 of FIG. 3 as at least some portion of determining if damage parameter criteria are active and satisfied. At 802, the computer-implemented method 800 can include determining a damage parameter value for a plurality of integration points of a contact element at the current substep. For example, the damage parameter values can be determined in accordance with the features of computer-implemented method 600 at 602 in accordance with one or more embodiments described herein.

At 804, the computer-implemented method 800 can comprise determining whether each integration point of the selected contact element has a damage parameter value greater than zero. Where one or more of the integration points have a damage parameter value equal to zero, the computer-implemented method 800 can proceed to 806. Where all the integration points have a damage parameter value greater than zero, the computer-implemented method 800 can proceed to 808.

At 806, the computer-implemented method 800 can determine that the first damage parameter based criterion is not satisfied. At 808, the computer-implemented method 800 can comprise determining a change of damage between integration points of the contact element. For example, the change of damage can be computed at 808 in accordance with Equation 2 described herein.

At 810, the computer-implemented method 800 can comprise determining whether the change of damage value is greater than a damage threshold value. In accordance with one or more embodiments described herein, the computer-implemented method 800 can determine that the first damage parameter based criterion is not satisfied at 812 based on the change of damage value being less than or equal to the damage threshold. Alternatively, the computer-implemented method 800 can determine that the first damage parameter based criterion is satisfied at 814 based on the change of damage value being greater than the damage threshold.

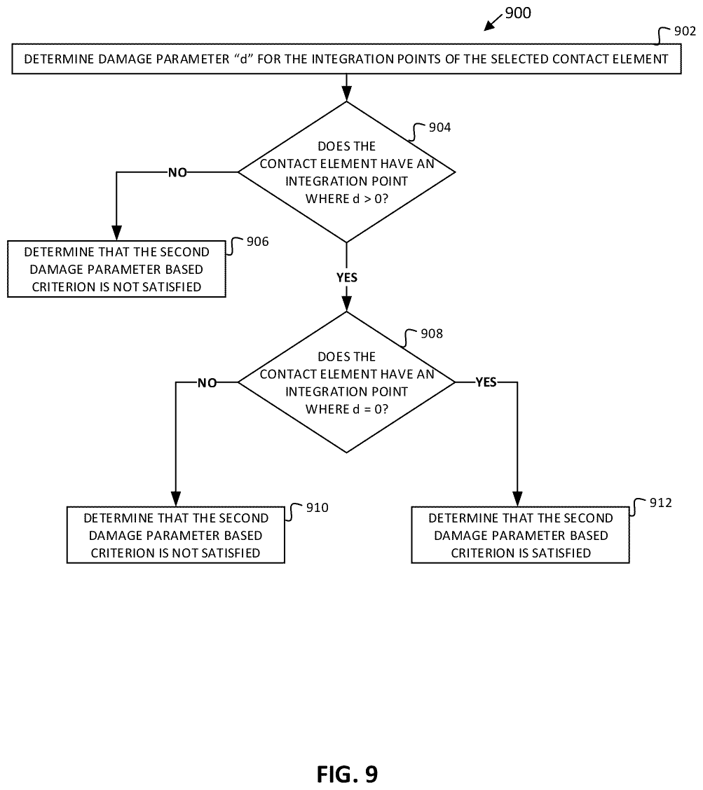

FIG. 9 illustrates a flow diagram of a non-limiting example computer-implemented method 900 that can be implemented by the system 100 to determine whether the second damage parameter based criterion is satisfied. The computer-implemented method 900 can be employed at 314 of FIG. 3 as at least some portion of determining if damage parameter criteria are active and satisfied. At 902, the computer-implemented method 900 can include determining a damage parameter value for a plurality of integration points of the selected contact element. The determination of the damage parameter values at 902 can be performed in accordance with the features of computer-implemented method 600 at 602.

At 904, the computer-implemented method 900 can comprise determining whether the contact element has at least one integration point having a damage parameter value greater than zero. Where the contact element does not have an integration point with a damage parameter greater than zero, the computer-implemented method 900 can proceed to 906. Where the contact element does have an integration point with a damage parameter value greater than zero, the computer-implemented method 900 can proceed to 908.

At 906, the computer-implemented method 900 can comprise determining that the second damage parameter based criterion is not satisfied. For example, the condition of the contact element may satisfy the first damage parameter based criterion, but not the second damage parameter based criterion.

At 908, the computer-implemented method 900 can comprise determining whether the contact element includes at least one integration point having a damage parameter value equal to zero. Where the contact element does not have an integration point with a damage parameter equal to zero, the computer-implemented method 900 can proceed to 910. Where the contact element does have an integration point with a damage parameter value equal to zero, the computer-implemented method 900 can proceed to 912.

At 910, the computer-implemented method 900 can comprise determining that the second damage parameter based criterion is not satisfied. For example, the condition of the contact element is undamaged, all damage parameter values are equal to zero and no damage parameter base criterion is satisfied. At 912, the computer-implemented method 900 can comprise determining that the second damage parameter based criterion is satisfied. For example, the contact element can be exhibiting an onset of damage. For instance, even where a difference between the damage parameter values of integration points is less than a damage threshold, the contact element can be proactively selected in association with a refining operation.

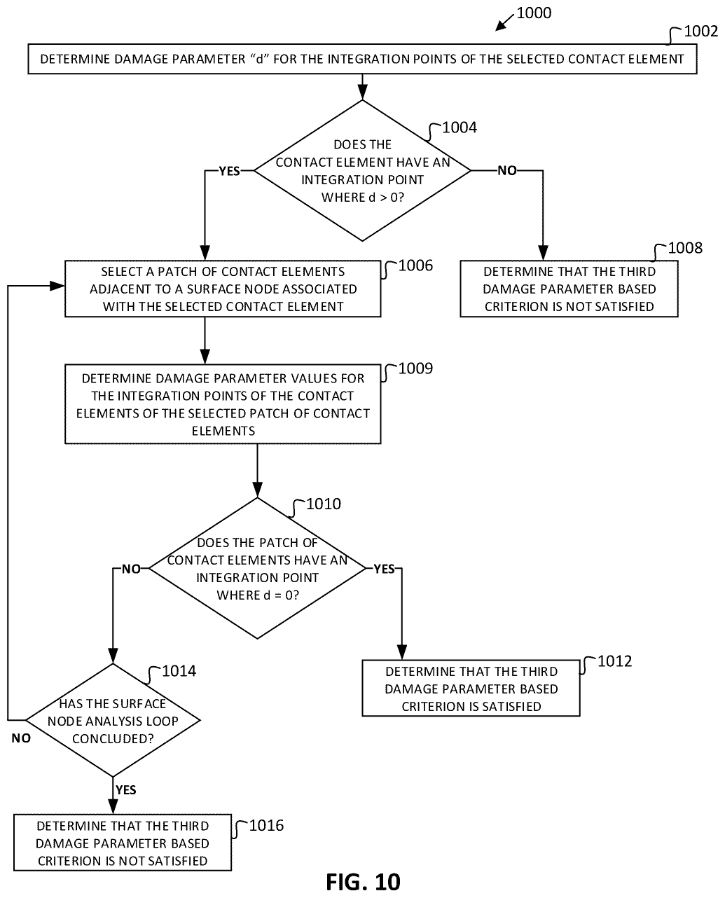

FIG. 10 illustrates a flow diagram of a non-limiting example computer-implemented method 1000 that can be implemented by the system 100 to whether the third damage parameter based criterion is satisfied. The computer-implemented method 1000 can be employed at 314 of FIG. 3 as at least some portion of determining if damage parameter criteria are active and satisfied. At 1002, the computer-implemented method 1000 can include determining a damage parameter value for a plurality of integration points of the selected contact element. The determination of the damage parameter values at 1002 can be performed in accordance with the features of computer-implemented method 600 at 602.

At 1004, the computer-implemented method 1000 can comprise determining whether the contact element has an integration point with a damage parameter value greater than zero. Where each integration point of the contact element is equal to zero, the computer-implemented method 1000 can proceed to 1008. Where the contact element has an integration point with a damage parameter value greater than zero, the computer-implemented method 1000 can proceed to 1006. At 1008, the computer-implemented method 1000 can comprise determining that the third damage parameter based criterion is not satisfied. For example, the condition of the contact element is undamaged, and no damage parameter based criterion is satisfied.

At 1006, the computer-implemented method 1000 can comprise selecting a patch of contact elements adjacent to a surface node associated with the selected contact element. For example, the selection at 1006 can be performed in accordance with the features of the computer-implemented method 600 at 606. At 1009, the computer-implemented method 1000 can comprise determining the damage parameter values for the integration points of the contact elements of the selected patch of contact elements. For example, the determinations at 1009 can be performed in accordance with the features of the computer-implemented method 600 at 608.

At 1010, the computer-implemented method 1000 can comprise determining whether the patch of contact elements has an integration point with a damage parameter value equal to zero. Where at least one integration point of the one or more contact elements of the selected patch has a damage parameter value equal to zero, the computer-implemented method 1000 can proceed to 1012. Where none of the integration points of the one or more contact elements of the selected patch has a damage parameter value equal to zero, the computer-implemented method 1000 can proceed to 1014.

At 1012, the computer-implemented method 1000 can comprise determining that the third damage parameter based criterion is satisfied. For example, the determination at 1012 can be indicative that the contact element is in proximity to another contact element that is exhibiting an onset of damage and/or active damage.

At 1014, the computer-implemented method 1000 can comprise determining whether the surface node analysis loop has concluded. For example, the surface node analysis loop can comprise features 1006 and 1009-1010, and can conclude once all the surface nodes associated with the selected contact element have been analyzed by the computer-implemented method 1000. Where at least one surface node associated with the contact element has yet to be analyzed by the computer-implemented method 1000, the computer-implemented method 1000 can proceed back to 1006 to select a new patch of contact elements with respect to an unanalyzed surface node associated with the contact element. Where each surface node associated with the contact element has been analyzed by the computer-implemented method 1000, the computer-implemented method 1000 can proceed to 1016 and determine that the third damage parameter based criterion is not satisfied.

FIG. 11 illustrates a flow diagram of a non-limiting example computer-implemented method 1100 that can be implemented by the system 100 to whether the fourth damage parameter based criterion is satisfied. The computer-implemented method 1100 can be employed at 314 of FIG. 3 as at least some portion of determining if damage parameter criteria are active and satisfied. At 1102, the computer-implemented method 1000 can include determining a damage parameter value for a plurality of integration points of the selected contact element. The determination of the damage parameter values at 1102 can be performed in accordance with the features of computer-implemented method 600 at 602.

At 1104, the computer-implemented method 1100 can comprise determining whether the contact element has an integration point with a damage parameter value greater than zero. Where the contact element has an integration point with a damage parameter value greater than zero, the computer-implemented method 1100 can proceed to 1106. Where the contact element does not have an integration point with a damage parameter value greater than zero, the computer-implemented method 1100 can proceed to 1108. At 1108, the computer-implemented method 1100 can comprise determining that the fourth damage parameter based criterion is not satisfied. For example, the condition of the contact element is undamaged and no damage parameter based criterion is satisfied.

At 1106, the computer-implemented method 1100 can comprise selecting a patch of contact elements adjacent to a surface node associated with the selected contact element. For example, the selection at 1106 can be performed in accordance with the features of the computer-implemented method 600 at 606. At 1110, the computer-implemented method 1100 can comprise determining the damage parameter values for the integration points of the contact elements of the selected patch of contact elements. For example, the determinations at 1110 can be performed in accordance with the features of the computer-implemented method 600 at 608.

At 1112, the computer-implemented method 1100 can comprise determining whether the change of the damage parameter value (Ad) between at least one integration point of the selected element and at least one integration point of the patch of elements is greater than the defined energy threshold value. For example, the change of damage parameter value can be determined for each integration point of the contact element with respect to each integration point of the selected patch of elements. Where the change in damage parameter value is greater than the defined energy threshold, the computer-implemented method 1100 can proceed to 1114. At 1114, the computer-implemented method 1100 can comprise determining that the fourth damage parameter based criterion is satisfied. Where the change in damage parameter value is less than or equal to the defined energy threshold, the computer-implemented method 1100 can proceed to 1116.

At 1116, the computer-implemented method 1100 can comprise determining whether the surface node analysis loop has concluded. For example, the surface node analysis loop can comprise features 1106 and 1110-1112, and can conclude once all the surface nodes associated with the selected contact element have been analyzed by the computer-implemented method 1100. Where at least one surface node associated with the contact element has yet to be analyzed by the computer-implemented method 1100, the computer-implemented method 1100 can proceed back to 1106 to select a new patch of contact elements with respect to an unanalyzed surface node associated with the contact element. Where each surface node associated with the contact element has been analyzed by the computer-implemented method 1100, the computer-implemented method 1100 can proceed to 1118 and determine that the fourth damage parameter based criterion is not satisfied.

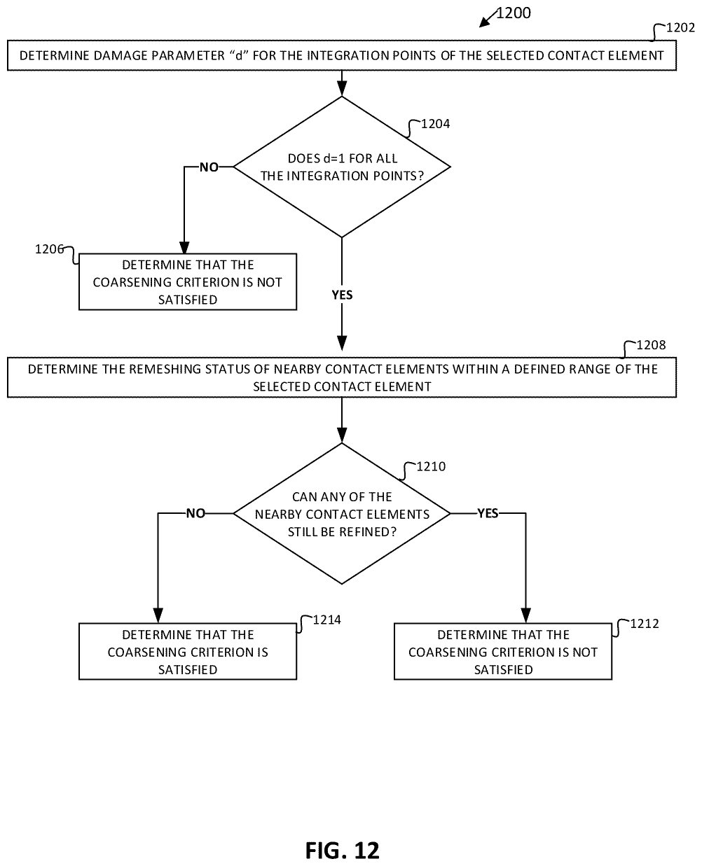

FIG. 12 illustrates a flow diagram of a non-limiting example computer-implemented method 1200 that can be implemented by the system 100 (e.g., by the debonding simulation solver 102 via the remeshing criteria analyzer 120) to determine whether the remeshing coarsening criterion is satisfied. The computer-implemented method 1200 can be employed (e.g., via the remeshing criteria analyzer 120) at 318 of FIG. 3. Various features of the computer-implemented method 1200 are described with reference to example surfaces of a cohesive zone shown in FIG. 13.

FIG. 13 depicts another view of the example cohesive zone 700, where the debonding has progressed with respect to the state shown in FIG. 7. Further, FIG. 13 depicts a slightly zoomed-out perspective; such that additional example contact elements 704 are visible, and an additional example target element is visible. The broken lines of the example contact surface 702 can represent an active proximity range 1302, which can include one or more further example contact elements 704. For instance, in the example embodiment depicted in FIG. 13, the first example contact element 704a is included within the active proximity range 1302. In various embodiments, the active proximity range 1302 can extend from the boundary of a contact element 704 selected for refining (e.g., a contact element 704 associated with a satisfied released energy remeshing criterion and/or one or more damage parameter based criteria). Additionally, the defined range can be composed of example contact elements 704 having a damage parameter value equal to one (e.g., where each example integration point 712 of the example contact element 704 is associated with a damage parameter value equal to one). In various embodiments, the active proximity range 1302 can be composed of elements associated with active cohesive zone behavior.

At 1202, the computer-implemented method 1200 can include determining a damage parameter value for a plurality of integration points of the selected contact element. The determination of the damage parameter values at 1202 can be performed in accordance with the features of computer-implemented method 600 at 602. At 1204, the computer-implemented method can include determining whether the damage parameter value for each of the integration points equals about one (e.g., in some embodiments a tolerance can be enabled, where a value of, for example, 0.99 or greater can be equated to a value of one). As described herein, a damage parameter value of one can indicate complete debonding between the contact element and scoped target element at the integration point. For example, where each integration point of a contact element is equal to one, the contact element can have an “open” contact status; thereby indicating that the contact element is not currently bonded to a target surface. This “open” contact status can thus represent a fully damaged integration point within a debonding simulation. Where one or more integration points has a damage parameter value less than one, the computer-implemented method 1200 can proceed to 1206. Where all the integration points have a damage parameter value equal to one, the computer-implemented method can proceed to 1208.

At 1206, the computer-implemented method 1200 can determine that the coarsening criterion is not satisfied. For example, when the condition of the contact element may satisfy one or more other remeshing criteria for refinement, it cannot satisfy the coarsening criterion. At 1208, the computer-implemented method 1200 can comprise determining the remeshing status of one or more nearby contact elements located within a defined range of the selected contact element. For example, the remeshing status can be an indication as to whether a contact element has been selected for, and/or is associated with, a refining operation (e.g., an indication as to whether a contact element satisfies the released energy criterion and/or one or more of the damage based parameter criteria) and has an active cohesive zone behavior (characterizing incipient or ongoing damage). The defined range can extend from each boundary of the selected contact element out to a pre-defined distance (e.g., a user-defined range that can be included in the initial conditions and end criteria 106) across the mesh. Where one or more contact elements within the defined range have yet to be analyzed by the remeshing criteria analyzer 120 for the given substep, the computer-implemented method 1200 can suspend analysis of the selected contact element until the nearby contact elements within the defined range have been analyzed with respect to the released energy criterion and/or the damage parameter based criteria. In another instance, the remeshing criteria analyzer 120 can apply one or more computer-implemented methods 400, 600, 700, 800, and 900 at 1208 to determine the remeshing status of the nearby contact elements (e.g., to determine the remeshing status of the contact elements within the defined range from the selected contact element).

At 1210, the computer-implemented method 1200 can comprise determining whether any of the nearby contact elements can still be selected for, and/or are associated with, a refining operation. For example, the determination at 1210 can include assessing as to whether any of the nearby contact elements satisfy the released energy criterion and/or one or more of the damage parameter based criteria. Where none of the nearby contact elements are associated with a refining operation, the computer-implemented method 1200 can proceed to 1214. Where one or more of the proximity contact elements are associated with a refining operation, the computer-implemented method 1200 can proceed to 1212.

At 1212, the computer-implemented method 1200 can comprise determining that the coarsening criterion is not satisfied. For example, at least because one or more of the proximity contact elements are associated with a refining operation, the computer-implemented method 1200 can determine at 1212 that the selected contact element is within a refinement proximity range. Contact elements within the refinement proximity range include those contact elements within the defined range of a contact element selected for a refining operation. Thus, contact elements within the refinement proximity range include those contact elements in proximity to one or more refining operations applied to the mesh. In one or more embodiments, contact elements within the refinement proximity range can be exempt from one or more coarsening operations, despite exhibiting an open contact status (e.g., where all integration points have a damage parameter value equal to one, indicating a completely debonded state from the target surface).

At 1214, the computer-implemented method 1200 can comprise determining that the coarsening criterion is satisfied. For example, with reference to the example cohesive zone 700 of FIG. 13, the fifth example contact element 704e and/or the sixth example contact element 704f can be distanced far enough away from the nearest contact element associated with active cohesive zone behavior (e.g., the second example contact element 704b) such that the fifth example contact element 704e and/or the sixth example contact element 704f can be outside the example active proximity range 1302. Further, each example integration point 712 of the fifth example contact element 704e and/or the sixth example contact element 704f are equal to one; thereby, the fifth example contact element 704e and/or the sixth example contact element 704f satisfy the coarsening criterion. For instance, the open contact status and distance from any refining operations for the given substep can render the fifth example contact element 704e and/or the sixth example contact element 704f eligible for one or more coarsening operations by the remeshing module 122.

As such, while previously described computer-implemented methods include refining areas of the mesh undergoing active or future damage, the computer-implemented method 1200 can facilitate coarsening areas of the mesh which have undergone damage and are no longer prioritized for the debonding simulation. The coarsening of elements selected by the computer-implemented method 1200 can reduce overall computational cost and time while maintaining computational efficiency and accuracy related to the debonding simulation.

### Experiment Data

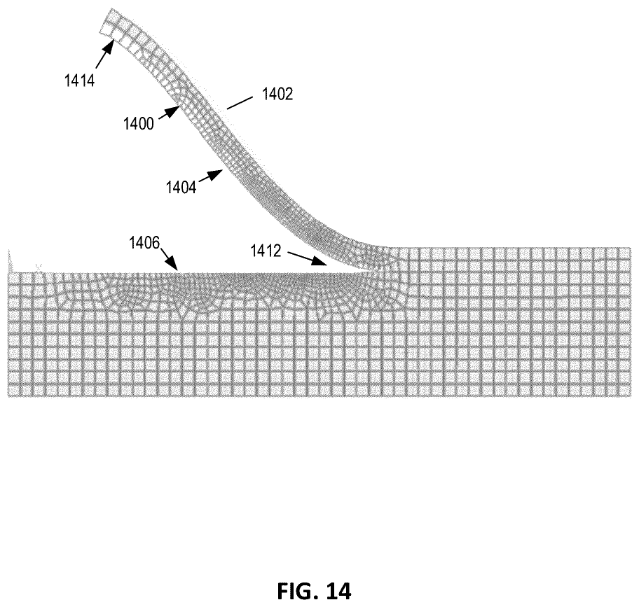

In an example experiment to demonstrate one or more features of the system 100 and the computer-implemented methods described herein, a debonding simulation was performed and depicted in FIG. 14

FIG. 14 illustrates results a mesh 1400 generated by the system 100 (e.g., applying computer-implemented methods 200, 300, 400, 600, 800, 900, 1000, and/or 1200) executing one or more remeshing operations (e.g., refining operations and/or coarsening operations) driven by the cohesive zone-based non-linear adaptivity remeshing criteria described herein. For example, as a result of the cohesive zone-based non-linear adaptivity remeshing criteria described herein, the system 100 focused one or more refining operations in areas exhibiting active debonding, such as area 1404 and/or area 1406 (e.g., where the refining operations increased the number of finite elements within area 1404 and/or area 1406). Further, the system 100 focused one or more coarsening operations in fully debonded areas that are distanced from the debonding location 1412, and thereby the active debonding process, such as area 1414. Area 1404 and/or area 1406 are depicted as highly refined in FIG. 14 to accurately capture the debonding mechanisms within the debonding simulation, while the damaged area 1414 is coarsened to prevent further increased computational cost and time. Further, the mesh 1400 can be seen to closely match the fine mesh solution 1402. While the mesh 1400 does not match the fine mesh solution 1402 with zero error, the coarsening and localized refinement of the mesh 1400 can enable faster, less costly simulations than that of the fine mesh solution 1402 wherein the entire domain is finely meshed.

In view of the foregoing structural and functional description, those skilled in the art will appreciate that portions of the embodiments can be embodied as a method, data processing system, or computer program product. Accordingly, these portions of the present embodiments can take the form of an entirely hardware embodiment, an entirely software embodiment, or an embodiment combining software and hardware, such as shown and described with respect to the computer system of FIG. 14. Furthermore, portions of the embodiments can be a computer program product on a computer-readable storage medium having computer readable program code on the medium. Any non-transitory, tangible storage media possessing structure can be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media can include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium can be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions can be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions can also be stored in computer-readable memory that can direct a computer or other programmable data processing apparatus to function in a particular manner, such that the instructions stored in the computer-readable memory result in an article of manufacture including instructions which implement the function specified. The computer program instructions can also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that can be described herein.

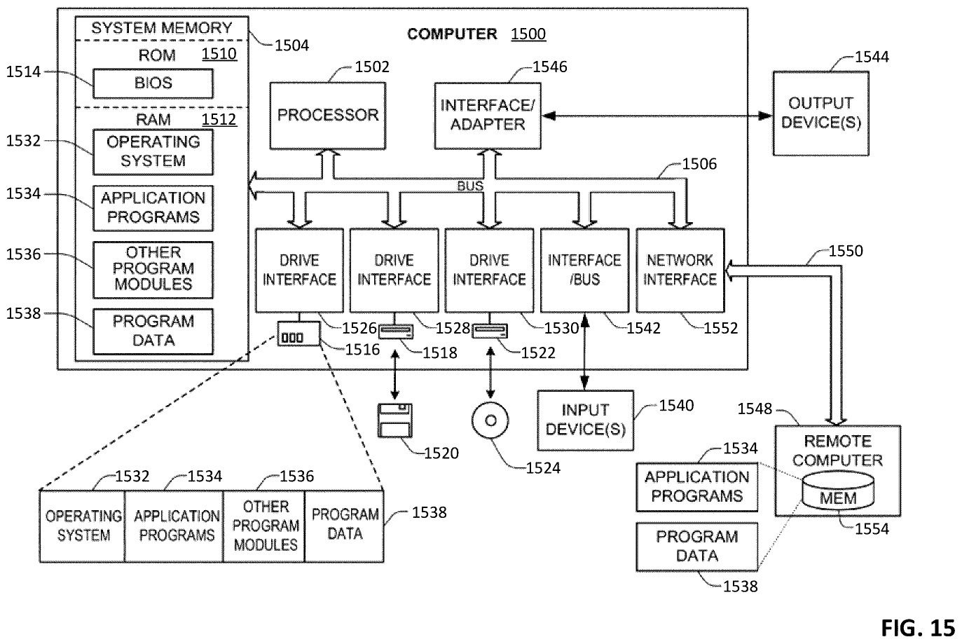

In this regard, FIG. 15 illustrates one example of a computer system 1500 that can be employed to execute one or more embodiments of the present disclosure. Computer system 1500 can be implemented on one or more general purpose networked computer systems, embedded computer systems, routers, switches, server devices, client devices, various intermediate devices/nodes or standalone computer systems. Additionally, computer system 1500 can be implemented on various mobile clients such as, for example, a personal digital assistant (PDA), laptop computer, pager, and the like, provided it includes sufficient processing capabilities.

Computer system 1500 includes processing unit 1502, system memory 1504, and system bus 1506 that couples various system components, including the system memory 1504, to processing unit 1502. System memory 1504 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 1502. System bus 1506 can be any of several types of bus structure including a memory bus or memory controller, a peripheral bus, and a local bus using any of a variety of bus architectures. System memory 1504 includes read only memory (ROM) 1510 and random access memory (RAM) 1512. A basic input/output system (BIOS) 1514 can reside in ROM 1510 containing the basic routines that help to transfer information among elements within computer system 1500.

Computer system 1500 can include a hard disk drive 1516, magnetic disk drive 1518, e.g., to read from or write to removable disk 1520, and an optical disk drive 1522, e.g., for reading CD-ROM disk 1524 or to read from or write to other optical media. Hard disk drive 1516, magnetic disk drive 1518, and optical disk drive 1522 are connected to system bus 1506 by a hard disk drive interface 1526, a magnetic disk drive interface 1528, and an optical drive interface 1530, respectively. The drives and associated computer-readable media provide nonvolatile storage of data, data structures, and computer-executable instructions for computer system 1500. Although the description of computer-readable media above refers to a hard disk, a removable magnetic disk and a CD, other types of media that are readable by a computer, such as magnetic cassettes, flash memory cards, digital video disks and the like, in a variety of forms, can also be used in the operating environment; further, any such media can contain computer-executable instructions for implementing one or more parts of embodiments shown and described herein.

A number of program modules can be stored in drives and ROM 1510, including operating system 1532, one or more application programs 1534, other program modules 1536, and program data 1538. In some examples, the application programs 1534 can include the debonding simulation solver 102, the debonding simulator 108, the active criteria tester 116, the non-linear adaptivity engine 118, or any of the testers, solvers, and modules within, and the program data 1538 can include the initial mesh 104, the initial conditions and end criteria 106, the output solution 128 and any interim solution data. The application programs 1534 and program data 1538 can include functions and methods programmed to perform debonding simulations while utilize cohesive zone-based criteria for localized refinement and coarsening, such as shown and described herein.

A user can enter commands and information into computer system 1500 through one or more input devices 1540, such as a pointing device (e.g., a mouse, touch screen), keyboard, microphone, joystick, game pad, scanner, and the like. For instance, the user can employ input device 1540 to edit or modify the initial mesh 104, the initial conditions and end criteria 106, or any additional internal criteria, variable, or parameter. These and other input devices 1540 are often connected to processing unit 1502 through a corresponding port interface 1542 that is coupled to the system bus, but can be connected by other interfaces, such as a parallel port, serial port, or universal serial bus (USB). One or more output devices 1544 (e.g., display, a monitor, printer, projector, or other type of displaying device) is also connected to system bus 1506 via interface 1546, such as a video adapter.

Computer system 1500 can operate in a networked environment using logical connections to one or more remote computers, such as remote computer 1548. Remote computer 1548 can be a workstation, computer system, router, peer device, or other common network node, and typically includes many or all the elements described relative to computer system 1500. The logical connections, schematically indicated at 1550, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1500 can be connected to the local network through a network interface or adapter 1552. When used in a WAN networking environment, computer system 1500 can include a modem, or can be connected to a communications server on the LAN. The modem, which can be internal or external, can be connected to system bus 1506 via an appropriate port interface. In a networked environment, application programs 1534 or program data 1538 depicted relative to computer system 1500, or portions thereof, can be stored in a remote memory storage device 1554.

The terminology used herein is for the purpose of describing particular embodiments only and is not intended to be limiting of the invention. As used herein, for example, the singular forms “a.” “an,” and “the” are intended to include the plural forms as well, unless the context clearly indicates otherwise. It will be further understood that the terms “contains”, “containing”, “includes”, “including,” “comprises”, and/or “comprising.” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” can indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

### Additional Embodiments

The present disclosure is also directed to the following exemplary embodiments, which can be practiced in any combination thereof.

Embodiment 1: A computer-implemented method, comprising determining, by the processor, a released energy, a damage parameter value, or a contact status of a contact element included within a first mesh that represents a region of physical objects simulated by a cohesive zone model: and remeshing, by the processor, a finite element associated with the contact element to generate a second mesh to represent the region based on the released energy. the damage parameter, or the contact status to obtain physical characteristics associated with a debonding of the physical objects.

Embodiment 2: The computer-implemented method of embodiment 1, further comprising: comparing, by the processor, the released energy to a threshold value, wherein the remeshing comprises refining the first mesh to generate the second mesh based on the released energy being greater than the threshold value.

Embodiment 3: The computer-implemented method of embodiments 1 or 2. wherein the released energy is a difference between a reference released energy and a most recently computed released energy of the contact element.

Embodiment 4: The computer-implemented method of any of embodiments 1-3, further comprising: computing, by the processor, the damage parameter as a function of damage associated with one or more integration points of the contact element: and comparing. by the processor, the damage parameter to a threshold value.

Embodiment 5: The computer-implemented method of any of embodiments 1-4, wherein the remeshing comprises refining the first mesh to generate the second mesh based on the damage parameter value being greater than the threshold value. Embodiment 6: The computer-implemented method of any of embodiments 1-5, further comprising: comparing, by the processor, a first damage parameter value associated with a first integration point of the contact element to a second damage parameter value associated with a second integration point of the contact element, wherein the remeshing comprises refining the first mesh to generate the second mesh based on the first damage parameter value characterizing damage to the contact element and the second damage parameter value characterizing substantially no damage to the contact element.

Embodiment 7: The computer-implemented method of embodiment 6, further comprising: remeshing, by the processor, a second finite element associated with a second contact element based on each integration point of the second contact element having a damage parameter value that characterizes substantially no damage to the second contact element, where the second contact element is adjacent to the contact element.

Embodiment 8: The computer-implemented method of any of embodiments 1-7, wherein the remeshing comprises coarsening the first mesh to generate the second mesh based on the contact status being indicative of the contact element being in a fully debonded state and the contact element being greater than a pre-defined distance from an active cohesive zone region of the cohesive zone model.

Embodiment 9: The computer-implemented method of any of embodiments 1-8, further comprising: mapping, by the processor, one or more debonding related solution variables from the first mesh to the second mesh: equilibrating, by the processor, unbalanced forces for the debonding on the second mesh: and simulating, by the processor, the debonding in the region represented as the second mesh.

Embodiment 10: A computer-implemented method, comprising: determining. by a processor, a released energy that characterizes a relative change of released energy of a contact element between substeps of a debonding in a region of physical objects simulated by a cohesive zone model, wherein the region is represented by a first mesh that includes the contact element: and remeshing, by the processor, a finite element associated with the contact element to generate a second mesh to represent the region based on the released energy to obtain physical characteristics associated with the debonding of the physical objects.

Embodiment 11: The computer-implemented method of embodiment 10, wherein the remeshing comprises refining the first mesh to generate the second mesh based on the released energy being greater than or equal to a threshold value.

Embodiment 12: The computer-implemented method of embodiments 10 or 11, wherein the scope of the refining is a function of the threshold value.

Embodiment 13: The computer-implemented method of any of embodiments 10-12, wherein the refining becomes increasing localized as the threshold value decreases in value.

Embodiment 14: The computer-implemented method of any of embodiments 10-13, wherein the contact element is scoped to a target element, and wherein the remeshing further comprises remeshing a finite element associated with the target element to generate the second mesh based on the comparing.

Embodiment 15: A computer-implemented method, comprising: determining, by a processor, a damage parameter value of a contact element included within a first mesh that represents a region of physical objects simulated by a cohesive zone model, wherein the damage parameter value is a function of displacement between the contact element and a target element: and remeshing, by the processor, a finite element associated with the contact element to generate a second mesh to represent the region based on the damage parameter or the contact status to obtain physical characteristics associated with a debonding of the physical objects.

Embodiment 16: The computer-implemented method of embodiment 15, further comprising: determining, by the processor, a relative change in damage between integration points of the contact element as a function of the damage parameter value: and comparing, by the processor, the relative change in damage to a threshold value.

Embodiment 17: The computer-implemented method of embodiments 15 or 16, wherein the remeshing comprises refining the first mesh to generate the second mesh based on the relative change in damage parameter value being greater than the threshold value.

Embodiment 18. The computer-implemented method of any of embodiments 15-17, further comprising: comparing, by the processor, a first damage parameter value of a first integration point of the contact element to a second damage parameter value of a second integration point of the contact element, wherein the remeshing comprises refining the first mesh to generate the second mesh based on the comparing being indicative of an onset of damage to the contact element.

Embodiment 19: The computer-implemented method of any of embodiments 15-18, further comprising: determining, by the processor, a third damage parameter value of a third integration point for a second contact element included in the first mesh, wherein the contact element and the second element are both adjacent to a node associated with the debonding simulated by the cohesive zone model: and comparing, by the processor, the third damage parameter value of the third integration point of the second contact element and the first damage parameter value of the first integration point of the contact element, wherein the remeshing comprises refining the first mesh to generate the second mesh based on the comparing being indicative of an onset of damage to the second contact element.

Embodiment 20: The computer-implemented method of any of embodiments 15-18, further comprising determining, by the processor, a relative change in damage parameter value between the first damage parameter value of the first integration point of the contact element and a third damage parameter value of a third integration point of a second contact element, wherein the remeshing comprises refining the first mesh to generate the second mesh based on the relative change in damage parameter value being greater than a defined threshold value.

What is claimed is:

1. A computer-implemented method, comprising:
determining, by a processor, a released energy, a damage parameter value, or a contact status of a contact element included within a first mesh that represents a region of physical objects simulated by a cohesive zone model; and
remeshing, by the processor, a finite element associated with the contact element to generate a second mesh to represent the region based on the released energy, the damage parameter value, or the contact status to obtain physical characteristics associated with a debonding of the physical objects.

2. The computer-implemented method of claim 1, further comprising:
comparing, by the processor, the released energy to a threshold value, wherein the remeshing comprises refining the first mesh to generate the second mesh based on the released energy being greater than the threshold value.

3. The computer-implemented method of claim 2, wherein the released energy is a difference between a reference released energy and a most recently computed released energy of the contact element.

4. The computer-implemented method of claim 1, further comprising:
computing, by the processor, the damage parameter value as a function of damage associated with one or more integration points of the contact element; and
comparing, by the processor, the damage parameter value to a threshold value.

5. The computer-implemented method of claim 4, wherein the remeshing comprises refining the first mesh to generate the second mesh based on the damage parameter value being greater than the threshold value.

6. The computer-implemented method of claim 1, further comprising:
comparing, by the processor, a first damage parameter value associated with a first integration point of the contact element to a second damage parameter value associated with a second integration point of the contact element, wherein the remeshing comprises refining the first mesh to generate the second mesh based on the first damage parameter value characterizing damage to the contact element and the second damage parameter value characterizing substantially no damage to the contact element.

7. The computer-implemented method of claim 6, further comprising:
remeshing, by the processor, a second finite element associated with a second contact element based on each integration point of the second contact element having a damage parameter value that characterizes substantially no damage to the second contact element, where the second contact element is adjacent to the contact element.

8. The computer-implemented method of claim 1, wherein the remeshing comprises coarsening the first mesh to generate the second mesh based on the contact status and/or damage parameter value being indicative of the contact element being in a fully debonded state and the contact element being greater than a pre-defined distance from an active cohesive zone region of the cohesive zone model.

9. The computer-implemented method of claim 1, further comprising:
mapping, by the processor, one or more debonding related solution variables from the first mesh to the second mesh;
equilibrating, by the processor, unbalanced forces for the debonding on the second mesh; and
simulating, by the processor, the debonding in the region represented as the second mesh.

10. A computer-implemented method, comprising:
determining, by a processor, a released energy that characterizes a relative change of released energy of a contact element between substeps of a debonding in a region of physical objects simulated by a cohesive zone model, wherein the region is represented by a first mesh that includes the contact element; and
remeshing, by the processor, a finite element associated with the contact element to generate a second mesh to represent the region based on the released energy to obtain physical characteristics associated with the debonding of the physical objects.

11. The computer-implemented method of claim 10, wherein the remeshing comprises refining the first mesh to generate the second mesh based on the released energy being greater than a threshold value.

12. The computer-implemented method of claim 11, wherein the scope of the refining is a function of the threshold value.

13. The computer-implemented method of claim 12, wherein the refining becomes increasingly localized as the threshold value decreases in value.

14. The computer-implemented method of claim 10, wherein the contact element is scoped to a target element, and wherein the remeshing further comprises remeshing a finite element associated with the target element to generate the second mesh based on the comparing.

15. A computer-implemented method, comprising:
determining, by a processor, a damage parameter value of a contact element included within a first mesh that represents a region of physical objects simulated by a cohesive zone model, wherein the damage parameter value is a function of displacement between the contact element and a target element; and
remeshing, by the processor, a finite element associated with the contact element to generate a second mesh to represent the region based on the damage parameter value to obtain physical characteristics associated with a debonding of the physical objects.

16. The computer-implemented method of claim 15, further comprising:
determining, by the processor, a relative change in damage between integration points of the contact element as a function of the damage parameter value; and
comparing, by the processor, the relative change in damage to a threshold value.

17. The computer-implemented method of claim 16, wherein the remeshing comprises refining the first mesh to generate the second mesh based on the relative change in damage parameter value being greater than the threshold value.

18. The computer-implemented method of claim 15, further comprising:
comparing, by the processor, a first damage parameter value of a first integration point of the contact element to a second damage parameter value of a second integration point of the contact element, wherein the remeshing comprises refining the first mesh to generate the second mesh based on the comparing being indicative of an onset of damage to the contact element.

19. The computer-implemented method of claim 18, further comprising:
determining, by the processor, a third damage parameter value of a third integration point for a second contact element included in the first mesh, wherein the contact element and the second element are both adjacent to a node associated with the debonding simulated by the cohesive zone model: and
comparing, by the processor, the third damage parameter value of the third integration point of the second contact element and the first damage parameter value of the first integration point of the contact element, wherein the remeshing comprises refining the first mesh to generate the second mesh based on the comparing being indicative of an onset of damage to the second contact element.

20. The computer-implemented method of claim 18, further comprising:
determining, by the processor, a relative change in damage parameter value between the first damage parameter value of the first integration point of the contact element and a third damage parameter value of a third integration point of a second contact element, wherein the remeshing comprises refining the first mesh to generate the second mesh based on the relative change in damage parameter value being greater than a defined threshold value.
